(19) United States
(12) Patent Application Publication
(10) Pub. No.: US 2026/0020616 A1
(43) Pub. Date: Jan. 22, 2026

(54) AEROSOL GENERATING SYSTEM

(71) Applicant: KT&G CORPORATION, Daejeon (KR)

(72) Inventors: Sang Kyu PARK, Seoul (KR); Hwi Kyeong AN, Seoul (KR)

(73) Assignee: KT&G CORPORATION, Daejeon (KR)

(21) Appl. No.: 19/260,992

(22) Filed: Jul. 7, 2025

(30) Foreign Application Priority Data
Jul. 18, 2024 (KR) 10-2024-0095160

(51) Int. Cl. A24F 40/51; A24F 40/57

(52) U.S. Cl. CPC A24F 40/51; A24F 40/57

(57) ABSTRACT

An aerosol generating system includes an aerosol generating article including a first region in which an identification material emitting light of a second wavelength different from a first wavelength, when excited by light of the first wavelength, is disposed, and a second region different from the first region, and an aerosol generating device having a cavity in which a part of the aerosol generating article is accommodated, wherein the aerosol generating device includes an inner wall defining the cavity and including, at one region, a transparent region through which light is transmitted, a sensor module including a light emitting unit configured to emit the light of the first wavelength toward the first region through the transparent region, and a light receiving unit configured to receive the light of the second wavelength emitted from the identification material of the aerosol generating article through the transparent region, a heater configured to heat the aerosol generating article accommodated in the cavity, and a control unit configured to determine information of the aerosol generating article based on a sensing value sensed through the light receiving unit, and control power supply to the heater based on the determined information of the aerosol generating article.

### CROSS-REFERENCE TO RELATED APPLICATION

This application is based on and claims priority under 35 U.S.C. § 119 to Korean Patent Application No. 10-2024-0095160, filed on Jul. 18, 2024, in the Korean Intellectual Property Office, the disclosure of which is incorporated by reference herein in its entirety.

### BACKGROUND

### 1. Field

The disclosure relates to an aerosol generating system capable of identifying a type of an accommodated aerosol generating article.

### 2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes.

Recently, aerosol generating devices with separate sensors have been diversified to detect whether aerosol generating articles have been inserted/removed, types of aerosol generating articles, and whether aerosol generating articles have been forged or altered. In particular, the types of aerosol generating articles have been diversified and the forged or altered aerosol generating articles exist in the market, and thus, the need for aerosol generating devices with a function of distinguish the aerosol generating articles is increasing. Aerosol generating devices may obtain information of aerosol generating articles through various sensors such as an inductive sensor, a capacitive sensor, a resistance sensor, an infrared sensor, a color sensor, etc.

### SUMMARY

An aerosol generating device may perform a heating operation on a specific type of cigarette through a specific heating profile corresponding to the corresponding cigarette. Therefore, it is necessary to improve the sensing accuracy of the cigarette such that an optimal smoking feeling may be provided from the cigarette.

Additional aspects will be set forth in part in the description which follows and, in part, will be apparent from the description, or may be learned by practice of the presented embodiments of the disclosure.

According to an embodiment, an aerosol generating system may include an aerosol generating article including a first region in which an identification material emitting light of a second wavelength different from a first wavelength, when excited by light of the first wavelength, is disposed, and a second region different from the first region, and an aerosol generating device having a cavity in which a part of the aerosol generating article is accommodated, wherein the aerosol generating device includes an inner wall defining the cavity and including, at one region, a transparent region through which light is transmitted, a sensor module including a light emitting unit configured to emit the light of the first wavelength toward the first region through the transparent region, and a light receiving unit configured to receive the light of the second wavelength emitted from the identification material of the aerosol generating article through the transparent region, a heater configured to heat the aerosol generating article accommodated in the cavity, and a control unit configured to determine information of the aerosol generating article based on a sensing value sensed through the light receiving unit, and control power supply to the heater based on the determined information of the aerosol generating article.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 to 3 are diagrams illustrating examples of aerosol generating articles;

FIG. 4 is a side cross-sectional view of an aerosol generating article for explaining examples of arrangement locations/methods of an identification material;

FIG. 5 is a perspective view of an aerosol generating article for explaining examples of arrangement locations/methods of an identification material;

FIG. 6 is a schematic side view of an aerosol generating system according to an embodiment;

FIG. 7 is a schematic side view of an aerosol generating system having a heating method different from that of the aerosol generating system of FIG. 6;

FIG. 8 is a flowchart in which an aerosol generating system controls power supply to a heater by determining information of an aerosol generating article according to an embodiment;

FIG. 9 is an example of a graph of a wavelength emitted from a first identification material when a wavelength in a first wavelength range is irradiated;

FIG. 10 is an example of a graph of a wavelength emitted from a second identification material when the wavelength in the first wavelength range is irradiated;

FIG. 11 is an example of a graph of a wavelength emitted from a third identification material when the wavelength in the first wavelength range is irradiated;

FIG. 12 is an example of a graph of a wavelength emitted from the third identification material when the wavelength in the first wavelength range is irradiated;

FIG. 13 is a flowchart of another specific example in which an aerosol generating system determines information of an aerosol generating article according to an embodiment;

FIGS. 14 to 18 are schematic conceptual diagrams of an aerosol generating system for explaining an arrangement of a sensor module according to an embodiment; and

FIG. 19 is a block diagram of an aerosol generating device according to an embodiment.

### DETAILED DESCRIPTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and changes such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and the generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. In this case, the ultrasonic vibration method may refer to a method of generating an aerosol by atomizing an aerosol generating material by using ultrasonic vibration generated by a vibrator.

The aerosol generating device may include a vibrator, and the vibrator may generate a short period of vibration to atomize the aerosol generating material. The vibration generated by the vibrator may be an ultrasound vibration, and the frequency band of the ultrasound vibration may be about 100 kHz to about 3.5 MHz, but is not limited thereto.

The aerosol generating device may further include a wick that absorbs the aerosol generating material. For example, the wick may be arranged to wrap at least one area of the vibrator or to be in contact with at least one area of the vibrator.

As the voltage (e.g., AC voltage) is applied to the vibrator, heat and/or ultrasonic vibration may be generated from the vibrator, and the heat and/or ultrasonic vibration generated from the vibrator may be transmitted to the aerosol generating material absorbed into the wick. The aerosol generating material absorbed into the wick may be converted to a gas phase by heat and/or ultrasonic vibration transmitted from the vibrator, and as a result, aerosol may be generated.

For example, the viscosity of the aerosol generating material absorbed into the wick by the heat generated from the vibrator may be lowered, and the aerosol generating material of which the viscosity is lowered by the ultrasonic vibration generated from the vibrator may be divided into fine particles, thereby generating aerosol, but embodiments are not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

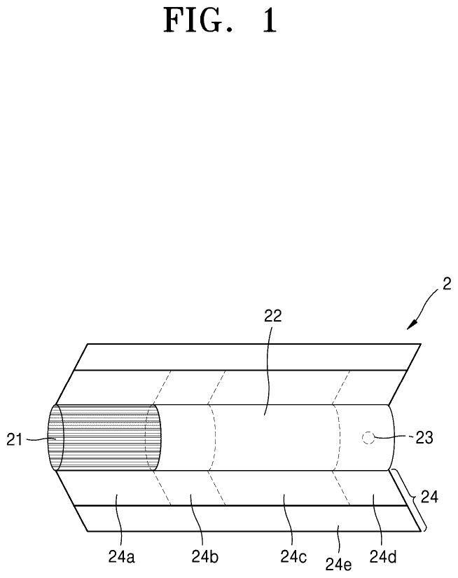

Hereinafter, examples of aerosol generating articles are described with reference to FIGS. 1 to 3.

FIGS. 1 to 3 are diagrams illustrating examples of aerosol generating articles.

In FIG. 1, a filter rod 22 is illustrated as a single segment, but is not limited thereto. In other words, the filter rod 22 may include a plurality of segments. For example, the filter rod 22 may include a first segment that cools an aerosol and a second segment that filters certain components included in the aerosol. In addition, when necessary, the filter rod 22 may further include at least one segment performing other functions.

An aerosol generating article 2 may be packaged by at least one wrapper 24. At least one hole through which external air is introduced or internal gas is discharged may be formed in the wrapper 24. As an example, the aerosol generating article 2 may be packaged by one wrapper 24. In another example, the aerosol generating article 2 may be overlappingly packaged by two or more wrappers 24. For example, a tobacco rod 21 may be packaged by a first rapper 24a, and the filter rod 22 may be packaged by wrappers 24b, 24c, and 24d. In addition, the entire aerosol generating article 2 may be repackaged by a single wrapper 24c. When the filter rod 22 includes a plurality of segments, the respective segments may be packaged by the wrappers 24b, 24c, and 24d.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, or oleyl alcohol, but is not limited thereto. In addition, the tobacco rod 21 may also include another additive, such as a flavoring agent, a humectant, and/or organic acid. In addition, a flavoring liquid, such as menthol or a humectant, may be added to the tobacco rod 21 by being sprayed onto the tobacco rod 21.

The tobacco rod 21 may be formed in various ways. For example, the tobacco rod 21 may include a sheet and a strand. In addition, the tobacco rod 21 may include cut fillers obtained by finely cutting a tobacco sheet. In addition, the tobacco rod 21 may be surrounded by a heat conductive material. For example, the heat conductive material may be a metal foil, such as aluminum foil, but is not limited thereto For example, the heat conductive material surrounding the tobacco rod 21 may evenly distribute the heat transferred to the tobacco rod 21 to improve the thermal conductivity applied to the tobacco rod 21, thereby improving the taste of tobacco. In addition, the heat conductive material surrounding the tobacco rod 21 may function as a susceptor heated by an induction heating-type heater. In this regard, although not shown in the drawing, the tobacco rod 21 may further include an additional susceptor besides the heat conductive material surrounding the outside.

The filter rod 22 may be a cellulose acetate filter. Meanwhile, there is no limitation on the shape of the filter rod 22. For example, the filter rod 22 may be a cylinder type rod or a tube type rod including a hollow inside. In addition, the filter rod 22 may be a recess type rod. When the filter rod 22 includes a plurality of segments, at least one of the plurality of segments may be formed in a different shape.

The filter rod 22 may generate flavor. For example, a flavoring liquid may be sprayed onto the filter rod 22, or a separate fiber coated with a flavoring liquid may be inserted inside the filter rod 22.

In addition, at least one capsule 23 may be included in the filter rod 22. Here, the capsule 23 may generate a flavor or an aerosol. For example, the capsule 23 may have a structure in which a liquid including a fragrance is wrapped with a film. The capsule 23 may have a spherical or cylindrical shape, but is not limited thereto.

When the filter rod 22 includes a segment that cools an aerosol, the cooling segment may include a polymer material or a biodegradable polymer material. For example, the cooling segment may include only pure polylactic acid (PLA), but is not limited thereto. Alternatively, the cooling segment may include a cellulose acetate filter including a plurality of holes. However, the cooling segment is not limited to the above-described examples, and a material that performs the function of cooling an aerosol may correspond to this without limitation.

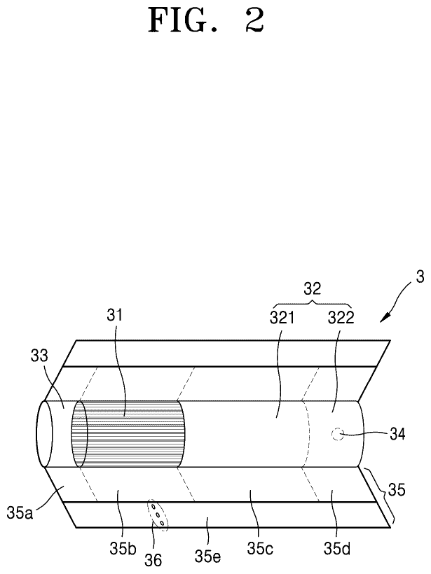

Referring to FIG. 2, an aerosol generating article 3 may further include a front end plug 33. The front end plug 33 may be located on one side of a tobacco rod 31 which is opposite to a filter rod 32. The front end plug 33 may prevent the tobacco rod 31 from escaping to the outside, and prevent a liquefied aerosol from the tobacco rod 31 from moving to an aerosol generating device during smoking.

The filter rod 32 may include a first segment 321 and a second segment 322. Here, the first segment 321 may correspond to a first segment of the filter rod 22 of FIG. 1, and the second segment 322 may correspond to a second segment of the filter rod 22 of FIG. 1.

The diameter and total length of the aerosol generating article 3 may correspond to the diameter and total length of the aerosol generating article 2 of FIG. 1. For example, the length of the front end plug 33 may be about 7 mm, the length of the tobacco rod 31 may be about 15 mm, the length of the first segment 321 may be about 12 mm, and the length of the second segment 322 may be about 14 mm, but the disclosure is not limited thereto.

The aerosol generating article 3 may be packaged by using at least one wrapper 35. The wrapper 35 may have at least one hole through which external air may be introduced or internal gas may be discharged. For example, the front end plug 33 may be packaged by a first wrapper 35a, the tobacco rod 31 may be packaged by a second wrapper 35b, the first segment 321 may be packaged by a third wrapper 35c, and the second segment 322 may be packaged by a fourth wrapper 35d.

In addition, the entire aerosol generating article 3 may be repackaged by a fifth wrapper 35c. In addition, at least one perforation 36 may be formed in the fifth wrapper 35e. For example, the perforation 36 may be formed in a region surrounding the tobacco rod, but is not limited thereto. The perforation 36 may serve to transfer heat formed by a heater to the inside of the tobacco rod 31.

In addition, at least one capsule 3 may be included in the second segment 322. Here, the capsule 34 may generate a flavor or an aerosol. For example, the capsule 34 may have a structure in which a liquid including a fragrance is wrapped with a film. The capsule 34 may have a spherical or cylindrical shape, but is not limited thereto.

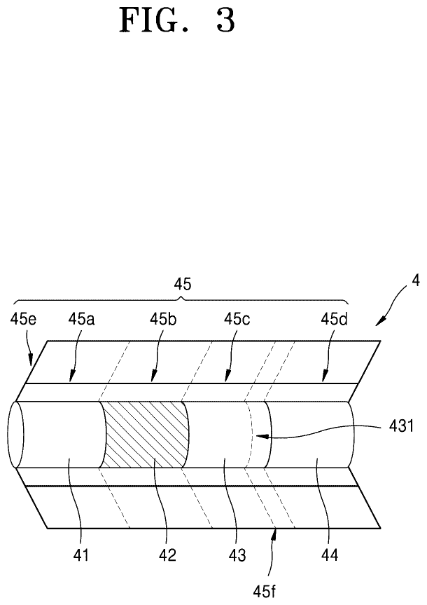

FIG. 3 is a diagram illustrating an example of an aerosol generating article.

Referring to FIG. 3, an aerosol generating article 4 may include a first aerosol generating rod 41, a second aerosol generating rod 42, a cooling rod 43, and a filter rod 44. In addition, the aerosol generating article 4 may be packaged by at least one wrapper 45.

The first aerosol generating rod 41, the second aerosol generating rod 42, the cooling rod 43, and the filter rod 44 may be arranged in order in a longitudinal direction of the aerosol generating article 4. Here, the longitudinal direction of the aerosol generating article 4 may be a direction in which the length of the aerosol generating article 4 extends. For example, the longitudinal direction of the aerosol generating article 4 may be a direction from the first aerosol generating rod 41 toward the filter rod 44.

Aerosols generated by the first aerosol generating rod 41 and the second aerosol generating rod 42 may pass through the first aerosol generating rod 41, the second aerosol generating rod 42, the cooling rod 43, and the filter rod 44 in order to form an airflow, and accordingly a smoker may inhale the aerosol from the filter rod 44.

The first aerosol generating rod 41 may be heated to generate an aerosol. The first aerosol generating rod 41 may include an aerosol generating material. In addition, the first aerosol generating rod 41 may include another additive, such as a humectant and/or organic acid, and include a flavoring liquid, such as menthol. For example, the aerosol generating material may include at least one of glycerin, propylene glycol, ethylene glycol, dipropylene glycol, diethylene glycol, triethylene glycol, tetraethylene glycol, or oleyl alcohol.

The first aerosol generating rod 41 may include an aerosol generating substrate impregnated with an aerosol generating material. The aerosol generating substrate may include a crimped sheet, and the aerosol generating material may be included in the first aerosol generating rod 41 in a state of being impregnated in the crimped sheet. In addition, other additives, such as flavoring agents, humectants, and/or organic acids, and a flavoring liquid may be included in the first aerosol generating rod 41 in a state of being absorbed in the crimped sheet.

The aerosol generating substrate may be disposed inside the first aerosol generating rod 41 in a wound state. The wound aerosol generating substrate may be wound around an axis extending in the longitudinal direction of the aerosol generating article 4, but is not limited thereto.

The crimped sheet may be a sheet formed of a polymer material. For example, the polymer material may include at least one of paper, cellulose acetate, lyocell, and polylactic acid. For example, the crimped sheet may be a paper sheet that does not generate an off-flavor due to heat, even when the crimped sheet is heated to a high temperature.

The first aerosol generating rod 41 may extend from the end of the aerosol generating article 4 to about 7 mm to about 20 mm, and the second aerosol generating rod 42 may extend from the end of the first aerosol generating rod 41 to about 7 mm to about 20 mm. However, the disclosure is not necessarily limited to such a numerical range, and the length in which each of the first aerosol generating rod 41 41 and the second aerosol generating rod 42 extends may be appropriately adjusted within a range that may be easily changed by one of ordinary skill in the art.

The second aerosol generating rod 42 may be heated to generate an aerosol including nicotine. In addition, the second aerosol generating rod 42 may include a tobacco material. The tobacco material may be in the form of a tobacco strand, a tobacco particle, a tobacco sheet, a tobacco bead, a tobacco granule, tobacco powder, or tobacco extract, but is not limited thereto.

For example, the second aerosol generating rod 42 may include a plurality of tobacco strands, and the plurality of tobacco strands may include cut tobacco sheets. The cut tobacco sheets may be obtained by cutting tobacco sheets. The cut tobacco sheets may be made by the following process. Tobacco raw materials are pulverized to make a slurry in which an aerosol generating material (e.g., glycerin, propylene glycol, etc.), a flavoring liquid, a binder (e.g., guar gum, xanthan gum, carboxymethyl cellulose, etc.), water, etc. are mixed. The slurry may include natural pulp or cellulose, and one or more binders may be mixed to be used as the slurry. The slurry may be cast to form a sheet, and then dried to make a tobacco sheet. The tobacco sheet may be cut or shredded to form a cut tobacco sheet. The tobacco raw material may be tobacco leaves, tobacco stems, and/or tobacco fines generated during tobacco processing. In addition, other additives, such as wood cellulose fibers, may also be included in the tobacco sheet.

In addition, the second aerosol generating rod 42 may include tobacco cut sheets made by mixing and processing various types of tobacco leaves, and then cutting the tobacco leaves. In addition, the second aerosol generating rod 42 may include a mixture of cut tobacco sheets and tobacco cut sheets.

In another example, the second aerosol generating rod 42 may include a plurality of tobacco granules. The tobacco granules may be particles each having a diameter of about 100 μm to about 2,000 μm. The plurality of tobacco granules may be manufactured by extruding a mixture of tobacco leaf powder, a pH adjuster, and a solvent.

The plurality of tobacco granules may be between filter materials. The filter materials may each include, for example, a fiber bundle of cellulose acetate fiber strands. The plurality of tobacco granules may be in a uniformly dispersed form between a plurality of cellulose fibers. In another example, the filter material may include a crimped paper sheet. The crimped paper sheet may be inside the second aerosol generating rod 42 in a wound state. The crimped paper sheet may be wound around an axis extending in the longitudinal direction of the second aerosol generating rod 42. The plurality of tobacco granules may be dispersed inside the wound paper sheet.

In addition, the second aerosol generating rod 42 may include an aerosol generating substrate impregnated with a liquid aerosol generating composition. The aerosol generating substrate may include a crimped sheet, and the liquid aerosol generating composition may be included in the second aerosol generating rod 42 in a state of being impregnated in the crimped sheet. The description above with respect to the aerosol generating substrate included in the first aerosol generating rod 41 may be equally applied to the aerosol generating substrate included in the second aerosol generating rod 42.

The liquid aerosol generating composition may include nicotine. The nicotine may include freebase nicotine and nicotine salt. The freebase nicotine may refer to neutral nicotine that has not been protonated. For example, when a strong base, such as ammonia, is added to a positively charged nicotine salt, the strong base may be converted into a cation, and the nicotine salt may become freebase nicotine, which is in a neutral state.

In addition, the liquid aerosol generating composition may include an aerosol generating material. The description above with respect to the aerosol generating substrate included in the first aerosol generating rod 41 may be equally applied to the aerosol generating material.

The liquid aerosol generating composition may be impregnated into the aerosol generating substrate in a ratio of about 0.05 g to about 1.0 g per 1 g of the aerosol generating material. For example, the liquid aerosol generating composition may be impregnated into the aerosol generating substrate in a ratio of about 0.1 g to about 0.8 g per 1 g of the aerosol generating material.

The cooling rod 43 may cool the aerosol generated in the first aerosol generating rod 41 and the second aerosol generating rod 42. The cooling rod 43 may include a biodegradable polymer material and have a cooling function. For example, the cooling rod 43 may include a PLA fiber, but is not limited thereto.

Alternatively, the cooling rod 43 may include a cellulose acetate filter. However, the cooling rod 43 is not limited to the above-described examples, and a material that performs the function of cooling an aerosol may correspond to this without limitation. In an embodiment, the cooling rod 43 may be a tube filter including a hollow or a paper tube including paper.

At least one hole 431 may be formed in an outer surface of the cooling rod 43. The at least one hole 431 may be formed in a circumferential direction of the cooling rod 43 to form one or more columns. The at least one hole 431 may allow external air to be introduced into the cooling rod 43. The external air introduced into the cooling rod 43 may be mixed with a high-temperature aerosol generated in the first aerosol generating rod 41 and the second aerosol generating rod 42 to cool the aerosol.

The filter rod 44 may filter some components included in an aerosol passing through the filter rod 44. The filter rod 44 may include a filter material. For example, the filter rod 44 may be a cellulose acetate filter. The filter rod 44 may be formed by adding a plasticizer (e.g., triacetin) to cellulose acetate tow.

There is no limitation on the shape of the filter rod 44. For example, the filter rod 44 may be a cylinder type rod or a tube type rod including a hollow inside. Alternatively, the filter rod 44 may be a recess type rod including a hollow having an open end. When the filter rod 44 includes a plurality of segments, at least one of the plurality of segments may be formed in a different shape.

The filter rod 44 may be formed to generate flavor. For example, a flavoring liquid may be sprayed onto the filter rod 44, or a separate fiber coated with a flavoring liquid may be inserted inside the filter rod 44.

In addition, at least one capsule may be included in the filter rod 44. Here, the capsule may generate a flavor or an aerosol. For example, the capsule may have a structure in which a liquid including a fragrance is wrapped with a film. The capsule may have a spherical or cylindrical shape, but is not limited thereto.

The aerosol generating article 4 may include a wrapper 45 surrounding at least some of the first aerosol generating rod 41 to the filter rod 44. In addition, the aerosol generating article 4 may include the wrapper 45 surrounding all the first aerosol generating rod 41 to the filter rod 44. The wrapper 45 may be located at the outermost part of the aerosol generating article 4, a single wrapper but a combination of a plurality of wrappers.

The aerosol generating article 4 may be wrapped overlappingly by two or more wrappers. For example, the first aerosol generating rod 41 may be packaged by a first wrapper 45a, the second aerosol generating rod 42 may be packaged by a second wrapper 45b, the cooling rod 43 may be packaged by a third wrapper 45c, and the filter rod 44 may be packaged by a fourth wrapper 45d. In addition, the entire aerosol generating article 4 may be repackaged by a fifth wrapper 45c.

The first wrapper 45a may surround the first aerosol generating rod 41, and the second wrapper 45b may surround the second aerosol generating rod 42. The first wrapper 45a and the second wrapper 45b may each be a combination of paper and metal foil, such as aluminum foil. For example, first wrapper 45a and the second wrapper 45b may each be a stack sheet in which paper and metal foil are stacked. The first wrapper 45a and the second wrapper 45b may each may be a stacked sheet in which the paper is disposed on one side of the metal foil or may be a stack sheet in which the paper is disposed on both sides of the metal foil.

The paper of the first wrapper 45a may include an oil-resistant material. For example, the paper of the first wrapper 45a may include polyvinyl alcohol (PVOH) or silicone. The paper of the first wrapper 45a may have a surface coated with polyvinyl alcohol or silicone.

The third wrapper 45c may surround the cooling rod 43. The third wrapper 45c may include a paper roll. The paper roll of the third wrapper 45c may be a porous roll or a non-porous roll. At least one perforation 45f may be formed in the third wrapper 45c. For example, the third wrapper 45c may wrap the cooling rod 43 having the at least one hole 431 formed therein, and the at least one perforation 45f formed in the third wrapper 45c may be formed at a location corresponding to the at least one hole 431 formed in the cooling rod 43.

The fourth wrapper 45d may surround the filter rod 44. The fourth wrapper 45d may include a hard roll having a greater thickness and basis weight than a general paper roll. For example, the hard paper may have a thickness of about 70 μm to about 150 μm, and a weight of about 50 g/m² to about 100 g/m². In addition, the hard paper may include an oil-resistant material. For example, the hard paper may have a surface treated with an oil-resistant material, such as polyvinyl alcohol or silicone.

The fifth wrapper 45e may collectively wrap the first aerosol generating rod 41 wrapped by the first wrapper 45a, the second aerosol generating rod 42 wrapped by the second wrapper 45b, the cooling rod 43 wrapped by the third wrapper 45c, and the filter rod 44 wrapped by the fourth wrapper 45d. The fifth wrapper 45e may prevent the outside of the aerosol generating article 4 from being contaminated by an aerosol generated by the aerosol generating article 4. Liquid materials may be generated from the aerosol generating article 4 by a user's puff. For example, the liquid materials (e.g., moisture, etc.) may be generated when the aerosol generated from the aerosol generating article 4 is cooled by external air. The fifth wrapper 45e wraps an outer surface of the aerosol generating article 4, and thus the generated liquid materials may be prevented from leaking out of the aerosol generating article 4.

Embodiments relate to an aerosol generating system capable of distinguishing different types of aerosol generating articles and identifying aerosol generating articles suitable for use with an aerosol generating device and aerosol generating articles unsuitable for use with the aerosol generating device.

To this end, the aerosol generating article according to an embodiment may include an identification material. The identification material may be disposed in one component of the aerosol generating article. For example, the identification material may be disposed on a wrapper, a filter rod, a tobacco rod, a front end plug, and/or an aerosol generating rod. The following embodiments will be described with respect to an example in which the identification material is disposed in the wrapper, but components in which the identification material may be disposed may be changed as described above.

The identification material may have physical, chemical or optical properties. The identification material may be a material having a property of changing the property of a wavelength of received light and emitting the light. Specifically, the identification material may be excited when light in a certain wavelength range is absorbed. In the disclosure, the term “excitation of a material” may mean that a state of the material changes from a ground state to an excited state. Thereafter, in a process of changing the state of the identification material from the excited state to the ground state, light in the certain wavelength range may be emitted from the identification material. For example, the identification material may be a material included in the lanthanide series and may include a material including at least one element of atomic numbers 57 to 71.

In an embodiment, the identification material may include a taggant. The taggant may include an identifiable spectral signature when absorbing light and/or emitting light. The taggant may absorb a specific range of wavelength when light is irradiated by a light emitting unit of the aerosol generating device. The taggant may be excited by absorbing light, and may emit at least one wavelength of light transitioned from the wavelength of the excited light. In this regard, the light emitted by the taggant may be in the form of photoluminescence and phosphorescence or fluorescence.

Light having a specific range of wavelength emitted by the taggant may be received by a light receiving unit of the aerosol generating device. Based on the wavelength of light received by the light receiving unit, the aerosol generating device may identify the type of the aerosol generating article.

The specific range of wavelength emitted by the taggant may be determined according to the amount, concentration, type, and/or composition ratio of a taggant material.

The taggant may include organic substances. In an embodiment, the taggant may include one or more kinds of organic substances selected from the group consisting of a quinazolinone-based compound, a thiophene-based compound, a sulfobenzoic acid-based compound, and a naphthyridine-based compound.

The quinazolinone-based compound may include a quinazolinone derivative or a salt thereof. For example, the quinazolinone-based compound may include 4(3H)-quinazolinone,6-chloro-2-(5-chloro-2-hydroxyphenyl), 4(3H)-quinazolinone,6-chloro-2-(4-chloro-2-hydroxyphenyl), 4(3H)-quinazolinone,7-chloro-2-(5-chloro-2-hydroxyphenyl), and 2-(5-chloro-2-hydroxyphenyl)-3H-quinazolin-4-on.

The thiophene-based compound may include a thiophene derivative or a salt thereof. For example, the thiophene-based compound may include 2,5-bis(5-tert-butyl-2-benzoxazolyl)thiophene.

The sulfobenzoic acid-based compound may include a sulfobenzoic acid derivative or a salt thereof. For example, the sulfobenzoic acid-based compound may include benzoic acid, 2-[(2-hydroxy-5-sulfobenzoyl)amino]-, and monosodium salt.

The naphthyridine-based compound may include a naphthyridine derivative or a salt thereof. For example, the naphthyridine-based compound may include a 1,8-naphthyridine derivative and a 1,5-naphthyridine derivative.

The taggant may also include inorganic substances. In an embodiment, the taggant may include one or more kinds of inorganic substances selected from the group consisting of rare earths, actinide metal oxides, and ceramics. For example, rare earths may include one kind of lanthanum selected from the group consisting of lanthanum, cerium, praseodymium, neodymium, promethium, samarium, europium, gadolinium, terbium, dysprosium, holmium, erbium, thulium, ytterbium, nitride, and lutetium.

In addition, the taggant may be a mixture of organic and inorganic substances. In an embodiment, the taggant may include a material in which organic and inorganic substances are covalently bonded, coordinately bonded, or ionic bonded. For example, the taggant may be a material in which inorganic and organic substances of the lanthanide series are coordinately bonded. For example, the taggant may include europium, tris[7-chloro-1-cyclopropyl-6-fluoro-1,4-dihydro-4-(oxo-kappaO)-1,8-naphthyridine.

In the identification material, a difference between a maximum absorption wavelength Absₘₐₓ with respect to light irradiated on the identification material and a dominant wavelength (DWL) of the emitted light may be about 20% or more with respect to the maximum absorption wavelength Absₘₐₓ. When the difference between the maximum absorption wavelength Absₘₐₓ and the DWL of the identification material has the above-described numerical range, significant identification accuracy may be achieved. When the difference between the maximum absorption wavelength Absₘₐₓ and the DWL of the identification material is less than about 20%, light reflected by a configuration other than the identification material may act as noise and reduce identification accuracy. For example, in the identification material, the difference between the maximum absorption wavelength Absₘₐₓ with respect to light irradiated on the identification material and the DWL of the emitted light may be about 25% to about 70% with respect to the maximum absorption wavelength Absₘₐₓ In addition, in the identification material, the difference between the maximum absorption wavelength Absₘₐₓ with respect to light irradiated on the identification material and the DWL of the emitted light may be about 30% to about 65% with respect to the maximum absorption wavelength Absₘₐₓ

### Experimental Example: Light Emission Experiment of Identification Material Including Taggant

A wavelength of the emitted light after irradiating light to the identification material including taggant was confirmed. The wavelength of the irradiated light was 365 nm, and results obtained by measuring the DWL of the emitted light are shown in Table 1 below.

Embodiment 1 shown in Table 1 is a quinazolinone-based compound such as 4-(3H)-quinazolinone, and 6-chloro-2-(5-chloro-2-hydroxyphenyl), Embodiment 2 is a quinazolinone-based compound such as 2-(5-chloro-2-hydroxy-phenyl)-3H-quinazolin-4-on, Embodiment 3 is a thiophene-based compound such as 2,5-bis(5-tert-butyl-2-benzoxazolyl)thiophene, and a sulfobenzoic acid-based compound such as benzoic acid, 2-[(2-hydroxy-5-sulfobenzoyl)amino]-, a mixture of monosodium salt (85˜90:10˜15 weight ratio), and Embodiment 4 is europium, tris[7-chloro-1-cyclopropyl-6-fluoro-1,4-dihydro-4-(oxo-kappaO)-1,8-naphthyridine.

TABLE 1

| | Maximum | | |
|---|---|---|---|
| | Absorption | | Dominant |
| | Wavelength | CIE Chromaticity | Wavelength |
| Classification | (nm, Absₘₐₓ) | Coordinates | (nm, DWL) |
| Embodiment 1 | 396 | X = 0.4300 ± 0.05 | 546.4 ± 5 |
| | | y = 0.5347 ± 0.05 | |
| Embodiment 2 | 382 | X = 0.3232 ± 0.05 | 518.8 ± 5 |
| | | Y = 0.5943 ± 0.05 | |
| Embodiment 3 | 364 | X = 0.1590 ± 0.05 | 471.3 ± 5 |
| | | Y = 0.1825 ± 0.05 | |
| Embodiment 4 | 382 | X = 0.6633 ± 0.02 | 622 ± 5 |
| | | Y = 0.3155 ± 0.02 | |

As may be seen in Table 1, it may be seen that in Embodiments 1 to 4, light is absorbed and excited, and light having a wavelength different from a wavelength of the absorbed light is emitted. In addition, it may be seen that in Embodiments 1 to 4, a difference between the maximum absorption wavelength Absₘₐₓ with respect to the irradiated light and the DWL of the emitted light is about 20% or more with respect to the maximum absorption wavelength Absₘₐₓ (Embodiment 1: about 38%, Embodiment 2: about 36%, Embodiment 3: about 29%, and Embodiment 4: about 63%).

The taggant may be added to a paper slurry or paste prior to drying of a component (e.g., wrapper) of the aerosol generating article, or painted or sprayed on the component. The taggant may be included within the component of the aerosol generating article in units of nanograms.

In an embodiment, an aerosol generating article 5 may include a taggant having a preset first content or more. Accordingly, the aerosol generating article 5 may include a sufficient amount of taggant to emit light of a wavelength of a specific region. For example, when the taggant is sprayed onto the surface, a sprayed solution may include the taggant at a concentration between about 1 ppm and about 1000 ppm. In another example, the taggant may be included on a wrapper at 6 mg/mm² or higher.

In an embodiment, the identification material solution may be applied to the surface of a component of the aerosol generating article 5. Here, the identification material solution may refer to a liquid composition including the identification material. For example, the identification material solution may be used to coat the surface of the wrapper of the aerosol generating article 5. In another example, the identification material solution may be printed on the surface of the wrapper of the aerosol generating article 5.

For example, the identification material solution may be prepared according to a manufacturing method including preparing an identification material, mixing the identification material and an overprint (OP) varnish to prepare a primary solution, and mixing the primary solution and a diluent to prepare the identification material solution. The prepared identification material may be applied to the component of aerosol generating article 5.

The preparing of the identification material may include pretreating the identification material to have a shape or physical property suitable for application to the component of aerosol generating article 5. For example, the identification material included in the identification material solution may be a plurality of particles each having a diameter of about 0.1 μm to about 10 μm. The identification material may be milled to have the diameter in the above-described range. When the identification material has the diameter in the above-described range, the identification material may be uniformly dispersed and disposed on the surface of the aerosol generating article 5 to which the identification material solution is applied, and printability may be improved. When the identification material has a diameter of less than about 0.1 μm, it may be difficult to detect the light emitted by the identification material. When the identification material has a diameter exceeding about 10 μm, uniform dispersion of the identification material may be difficult, and printability may be degraded. The identification material may have, for example, a diameter of about 0.5 μm to about 5 μm, or a diameter of about 0.7 μm to about 3 μm.

The identification material solution may include an OP varnish. In the disclosure, the OP varnish may refer to liquid coating solidified by curing. For example, the OP varnish may include one or more kinds of materials selected from the group consisting of nitrocellulose, polyamide, propyl acetate, isopropyl alcohol, ethyl acetate, and 1,2-cyclohexane dicarboxylic acid diisononyl ester (DINCH).

The identification material solution may include a diluent. The diluent may be used for gravure printing or offset printing known in the art. For example, the diluent may include one or more kinds of materials selected from the group consisting of water, alcohols with 1 to 4 carbon atoms, vegetable oil, fatty amine, propyl acetate, isopropyl alcohol, and ethyl acetate. The vegetable oil may include one or more kinds of oils selected from the group consisting of flaxseed oil, soybean oil, castor oil, corn oil, tung oil, otticita oil, and coconut oil. The fatty amine may be one or more kinds of amine selected from the group consisting of oleyl amine, stearyl amine, and oleyl diamine.

For example, the identification material solution may include about 0.01 wt % to about 20 wt % of the identification material, about 10 wt % to about 40 wt % of the OP varnish, and about 50 wt % to about 85 wt % of the diluent, but is not limited thereto. The identification material solution may include about 0.05 wt % to about 10 wt % of the identification material, about 15 wt % to about 30 wt % of the OP varnish, and about 60 wt % to about 80 wt % of the diluent.

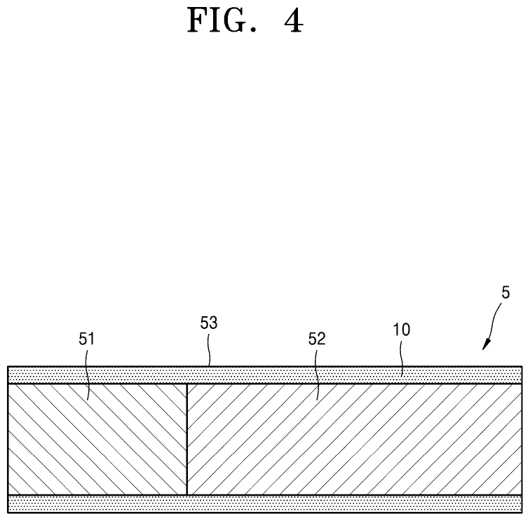

FIG. 4 is a side cross-sectional view of the aerosol generating article 5 for explaining examples of arrangement locations/methods of an identification material.

The aerosol generating article 5 may include an identification material 10, a tobacco rod 51, a filter rod 52, and a wrapper 53. At least one of components of the aerosol generating article 5 shown in FIG. 4 may be the same as or similar to at least one of the components of the aerosol generating article described above, and thus redundant descriptions thereof are omitted below. It will be appreciated that some components and structures may be replaced, added, or omitted as will be readily understood by one of skilled in the art with reference to the following drawings and description.

The identification material 10 (taggant) may be uniformly disposed over the entire region of the wrapper 53 in a longitudinal direction of the wrapper 53. Accordingly, a sensor module of an aerosol generating device may sense the entire region of the wrapper 53 in which the identification material 10 is arranged, and thus the degree of freedom with respect to the arrangement structure of the sensor module may be improved. Accordingly, the case of a manufacturing process of the aerosol generating device may be improved.

In addition, the identification material 10 is exposed to an outer surface of the wrapper 53, and thus the sensor module of the aerosol generating device may easily recognize the identification material 10. That is, the sensitivity of the sensor module may be improved.

The identification material 10 may be uniformly disposed over the entire region of the wrapper 53 by being added to a paper slurry or paste during a manufacturing process of the wrapper 53.

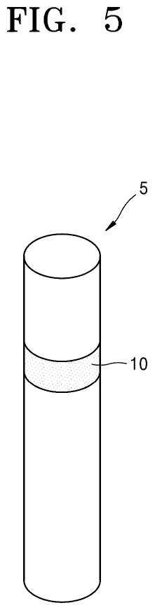

FIG. 5 is a perspective view of an aerosol generating article 5 for explaining examples of arrangement locations/methods of an identification material.

The aerosol generating article 5 shown in FIG. 5 may be at least one of the aerosol generating articles described above, and thus a redundant description is omitted below.

In The aerosol generating article 5, at least one configuration, or features of the above-described embodiments may be combined as long as they are not technically obviously impossible. For example, in the embodiment described in FIG. 5, the identification material 10 is disposed on an outer surface of a wrapper, but is not limited thereto, and the identification material 10 shown in FIG. 5 may be disposed on an inner surface of the wrapper.

Referring to FIG. 5, the identification material 10 may be disposed in a circumferential direction of the aerosol generating article 5, but may be disposed only partially in a longitudinal direction of the aerosol generating article 5. In this case, a sensor module of an aerosol generating device may be disposed at a certain location in the circumferential direction of the aerosol generating article 5 to recognize the identification material 10, and thus the degree of freedom in the arrangement structure of the sensor module may be improved.

In addition, compared to an embodiment in which the identification material 10 is disposed in the entire region in the longitudinal direction of the wrapper, the amount of identification material 10 used may be reduced.

For example, a region in which the identification material 10 is disposed may extend by about 1 mm to about 10 mm in the longitudinal direction of the aerosol generating article 5. For example, the region in which the identification material 10 is disposed may extend by about 2 mm to about 7 mm in the longitudinal direction of the aerosol generating article 5.

Additionally, the aerosol generating article 5 may include an aerosol generating rod and a filter rod that are aligned in order in the longitudinal direction of aerosol generating article 5, and the identification material 10 may be disposed in a region extending from a boundary of the aerosol generating rod and the filter rod toward the aerosol generating rod.

The length from a downstream end of the region in which the identification material 10 is disposed to the boundary between the aerosol generating rod and the filter rod may be about 0 mm to about 5 mm. In the above-described range, heat applied to the aerosol generating article 5 may be prevented from being transferred to the identification material 10. For example, the length from a downstream end of the region in which the identification material 10 is disposed to the boundary between the aerosol generating rod and the filter rod may be from about 1 mm to about 3 mm.

The identification material 10 is disposed only in one region of the aerosol generating article 5, and thus the structure of the sensor module of the aerosol generating device for recognizing the identification material 10 may be implemented to be changed without being fixed to a specific location.

Here, “upstream” and “downstream” may be determined based on a direction in which air flows when a user inhales an aerosol by using the aerosol generating article 5. For example, when a user inhales an aerosol by using the aerosol generating article 5 shown in FIG. 5, air may move from a lower portion of the aerosol generating article 5 to an upper portion thereof in FIG. 5. In addition, one of ordinary skill in the art will easily understand that “upstream” and “downstream” may be relative depending on relationships between components.

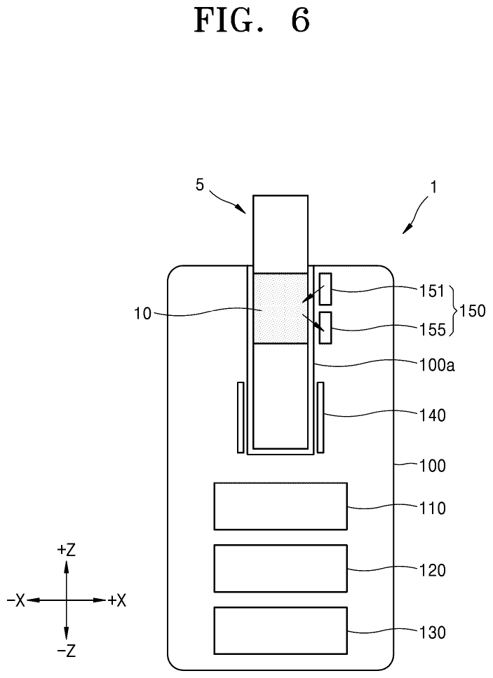

FIG. 6 is a schematic side view of an aerosol generating system according to an embodiment. In the disclosure, the aerosol generating system may be used in the sense of including an aerosol generating article and an aerosol generating device.

Referring to FIG. 6, an aerosol generating device 1 may include an aerosol generating device main body 100, a control unit 110, a battery 120, a memory 130, a heater 140, and a sensor module 150. However, the components of the aerosol generating device 1 are not limited thereto, and another component may be added or at least one component may be omitted according to an embodiment.

In addition, at least one of components of the aerosol generating system shown in FIG. 6 may be the same as or similar to at least one of the components of the aerosol generating system described above, and thus redundant descriptions thereof are omitted below. It will be appreciated that some components and structures may be replaced, added, or omitted as will be readily understood by one of skilled in the art with reference to the following drawings and description.

The aerosol generating device main body 100 may form the overall appearance of the aerosol generating device 1. The aerosol generating device main body 100 may accommodate the components of the aerosol generating device 1.

A cavity 100a in which the aerosol generating article 5 may be accommodated may be formed in the aerosol generating device main body 100. The aerosol generating article 5 accommodated in the cavity 100a may be heated by the heater 140. The cavity 100a may be an elongated cavity, a coupling region, an insertion region, or a heating region accommodating the aerosol generating article 5. The cavity 100a may have a shape corresponding to at least a partial region of the aerosol generating article 5. For example, the cavity 100a may have a shape extending in one direction (e.g., −Z direction) from an opening. The aerosol generating article 5 may pass through the opening and be inserted into the cavity 100a in a longitudinal direction.

The aerosol generating article 5 accommodated in the cavity 100a may include the identification material 10 described above. The identification material 10 may be provided in at least a partial region of an outer peripheral surface of the aerosol generating article 5. When the aerosol generating article 5 is accommodated in the cavity 100a, the identification material 10 may be located inside the aerosol generating device main body 100.

The control unit 110 may control general operations of the aerosol generating device 1. The control unit 110 may be implemented as an array of a plurality of logic gates or may be implemented as a combination of a general-purpose microprocessor and a memory in which a program executable in the microprocessor is stored, but is not limited thereto.

The control unit 110 may control power supplied from the battery 120 to the heater 140. For example, the control unit 110 may control the amount and duration of the power supplied from the battery 120 to the heating portion so that the heater 140 is heated to a certain temperature or maintained at a specified temperature.

In an embodiment, the control unit 110 may receive a detection result from the sensor module 150. The memory 130 may be connected to the control unit 110 and may store executable instructions. The control unit 110 may control the driving of the aerosol generating device 1 by executing the instructions stored in the memory 130.

In an embodiment, the control unit 110 may recognize identification information of the aerosol generating article 5 based on the amount of light emitted from the identification material 10, by receiving a detection result from the sensor module 150 and executing an instructions related to the sensor module 150 among the instructions stored in the memory 130. For example, the identification information may be information about the type of the aerosol generating article 5, whether the aerosol generating article 5 is genuine, and/or a including material of the aerosol generating article 5. The control unit 110 may control the operation of the aerosol generating device 1 based on the recognized identification information.

Specifically, the control unit 110 may control power supplied to the heater 140 based on the determined information of the aerosol generating article 5. The control unit 110 may differently control the driving of the heater 140 based on the identification information, by executing instructions related to the driving of the heater 140 among the instructions stored in the memory 130.

The battery 120 may supply power used for the operation of the aerosol generating device 1. For example, the battery 120 may be electrically connected to the heater 140 and supply power such that the heater 140 may be heated. In addition, the battery 120 may supply power necessary for the operation of other components (e.g., the control unit 110) of the aerosol generating device 1. The battery 120 may be a rechargeable battery or a disposable battery. For example, the battery 120 may be a lithium polymer (LiPoly) battery, but the type of battery 120 is not limited thereto.

The memory 130, which is hardware storing various types of data processed within the aerosol generating device 1, may store pieces of data processed by the control unit 110 and pieces of data to be processed by the control unit 110.

The memory 130 may store information about an appropriate temperature profile and driving based on various pieces of information such as the type of the aerosol generating article 5, the type of the including material, the content of the material, and the degree of hyperhumidity. The control unit 110 may perform an operation corresponding to the aerosol generating article 5, by executing instructions of information (e.g., driving period, driving intensity, etc.) about driving of the heater 140 from the memory 130 based on the identification material 10.

The heater 140 may receive power from the battery 120 and heat at least a part of the aerosol generating article 5. For example, the heater 140 may be disposed outside a tobacco rod of the aerosol generating article 5 to heat the tobacco rod.

The heater 140 is not limited to the example shown in FIG. 6. That is, the heater 140 shown in FIG. 6 is disposed outside the aerosol generating article 5, but the heater 140 may include a tubular heating element, a plate-shaped heating element, a needle-shaped heating element, or a rod-shaped heating element. In this regard, the heater 140 may be inserted into the aerosol generating article 5 to heat the inside of the aerosol generating article 5.

The sensor module 150 may detect the identification material 10 of the aerosol generating article 5. In addition, the sensor module 150 may detect whether the aerosol generating article 5 is inserted into the cavity 100a.

The sensor module 150 may be disposed on the aerosol generating device main body 100 to recognize the identification material 10 of the aerosol generating article 5. The sensor module 150 may be disposed in the cavity 100a to be located at a corresponding position of the identification material 10.

The sensor module 150 may include a light emitting unit 151 and a light receiving unit 155.

The light emitting unit 151 may emit light of a first wavelength toward the cavity 100a. For example, the light emitting unit 151 may include at least one light emitting diode that emits light of a first wavelength when current flows.

In an embodiment, at least a part of the light of the first wavelength emitted by the light emitting unit 151 may be transmitted to the identification material 10 of the aerosol generating article 5. The light of the first wavelength may be excited in the identification material 10, and the identification material 10 may emit light of a second wavelength different from the first wavelength. Optical properties such as the wavelength and amount of light emitted from the identification material 10 may be determined according to the amount, concentration, type, and/or composition ratio of the identification material 10.

The light receiving unit 155 may receive light emitted from the identification material 10 of the aerosol generating article 5. For example, the light receiving unit 155 may include at least one light receiving diode through which current flows when light is irradiated.

The light receiving unit 155 may detect an optical characteristic (e.g., an amount of the light of the second wavelength) of light emitted from the aerosol generating article 5 to recognize identification information of the aerosol generating article 5. The light receiving unit 155 may provide the detection result to the control unit 110.

Hereinafter, the light of the first wavelength emitted by the light emitting unit 151 and the light of the second wavelength received by the light receiving unit 155 are described.

In an embodiment, the light of the first wavelength may be infrared ray, and the light of the second wavelength may be infrared ray having a wavelength different from the first wavelength. For example, the first wavelength may be in the range of 930 nm to 990 nm. The second wavelength may be in the range of 1000 nm to 1020 nm. For example, the first wavelength may be a wavelength of 980 nm, and the second wavelength may be a wavelength of 1012 nm.

Accordingly, the sensor module 150 may recognize the identification information of the aerosol generating article 5 without being visually exposed to the user, by using the light of the first wavelength and the light of the second wavelength including infrared rays.

In an embodiment, the light of the first wavelength may be ultraviolet light, and the light of the second wavelength may be infrared ray. For example, the first wavelength may be in the range of 300 nm to 340 nm. The second wavelength may be in the range of 1000 nm to 1020 nm. For example, the first wavelength may be a wavelength of 320 nm, and the second wavelength may be a wavelength of 1012 nm.

In an embodiment, the light of the first wavelength may be ultraviolet light, and the light of the second wavelength may be visible light. In this regard, the light receiving unit 155 may be a color sensor. The color sensor may include a red green blue (RGB) sensor or an XYZ optical sensor for measuring, discriminating, or distinguishing the color of an identification indication. The RGB sensor may include light sources of three colors, and detect color information by reflecting light to an object. The XYZ optical sensor may include an optical-to-digital converter and detect a xy chromaticity coordinate according to the Commission Internationale de l'Eclairage (CIE) 1931 color space.

For example, the first wavelength may be in the range of 340 nm to 375 nm, and the second wavelength may be in the range of 380 nm to 780 nm. For example, the first wavelength may be a wavelength of 365 nm, and the second wavelength may be a wavelength (red light) in the range of 613 nm to 627 nm. In another example, the first wavelength may be a wavelength of 365 nm, and the second wavelength may be a wavelength (yellow light) of 540 nm to 551 nm. In addition, the first wavelength may be a wavelength of 365 nm, and the second wavelength may be a wavelength (green light) of 513 nm to 537 nm. In addition, the first wavelength may be a wavelength of 365 nm, and the second wavelength may be a wavelength (blue light) of 437 nm to 477 nm.

In an embodiment, the light of the first wavelength may be visible light, and the light of the second wavelength may be visible light of a different wavelength band from the light of the first wavelength. In this case, the light receiving unit 155 may be a color sensor.

For example, the first wavelength may be a wavelength in the range of 380 nm to 420 nm, and the second wavelength may be a wavelength in the range of 490 nm to 570 nm. For example, the first wavelength may be a wavelength (purple) of 400 nm, and the second wavelength may be a wavelength (green light) of 500 nm.

In an embodiment, the first wavelength may be a wavelength in the range of 600 nm to 900 nm, and the second wavelength may be a wavelength in the range of 1000 nm to 1020 nm. For example, the first wavelength may be a wavelength of 700 nm, and the second wavelength may be a wavelength of 1012 nm. In this case, the sensor module 150 may include a near-infrared (NIR) sensor.

As described above, the sensor module 150 may improve the identification accuracy of the aerosol generating article 5, by using different types of light (or light having a relatively large wavelength change) with the light of the first wavelength and the light of the second wavelength.

For example, based on a sensing value of about 1012 nm received through the light receiving unit 155, the control unit 110 may determine that the aerosol generating article 5 inserted into the aerosol generating device 1 is first type of aerosol generating article 5. For another example, based on the sensing value of about 1012 nm received through the light receiving unit 155, the control unit 110 may determine that the aerosol generating article 5 inserted into the aerosol generating device 1 is a genuine article that has not been forged or altered.

When it is determined that the type of the aerosol generating article 5 is the first type of aerosol generating article 5, the control unit 110 may control power supply to the heater 140 based on a temperature profile corresponding to the first type of aerosol generating article 5. For another example, when it is determined that the aerosol generating article 5 is a forged or altered article, the control unit 110 may not supply power to the heater 140 or may cut off the power being supplied.

When the type of the aerosol generating article 5 is detected based on the sensing value sensed through the light receiving unit 155, the battery 120 may supply power to the heater 140 according to a temperature profile corresponding to the detected type of aerosol generating article 5. For another example, when it is determined that the aerosol generating article 5 is a forged or altered article based on the sensing value sensed through the light receiving unit 155, the battery 120 may not supply power to the heater 140.

The light emitting unit 151 and the light receiving unit 155 may be disposed adjacent to the cavity 100a. For example, the light emitting unit 151 and the light receiving unit 155 may be spaced apart by a certain distance in a z-axis direction in a direction in which the cavity 100a extends. In another example, the light emitting unit 151 and the light receiving unit 155 may be spaced apart by a certain distance in an x-axis direction crossing the direction in which the cavity 100a extends to surround at least one region of the cavity 100a. In this regard, the “at least one region of cavity” may refer to a region corresponding to a region in which the identification material 10 is disposed in the aerosol generating article 5 when the aerosol generating article 5 is accommodated in the cavity 100a.

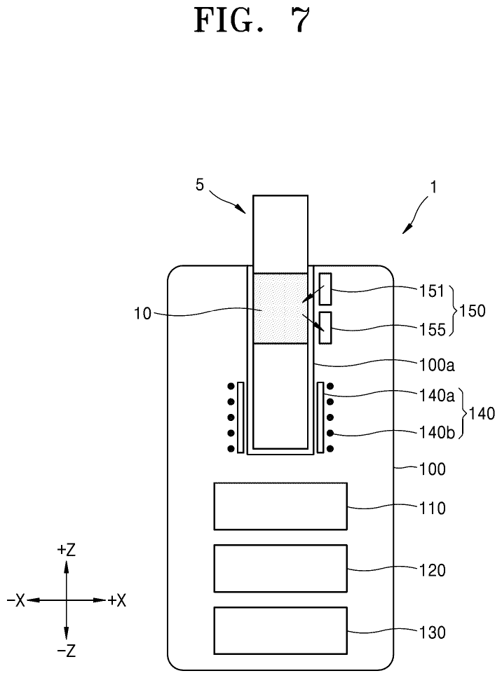

FIG. 7 is a schematic side view of an aerosol generating system having a heating method different from that of the aerosol generating system of FIG. 6.

Referring to FIG. 7, an aerosol generating device 1 may include an aerosol generating device main body 100, a control unit 110, a battery 120, a memory 130, a heater 140, and a sensor module 150. At least one of components (e.g. the sensor module 150) of the aerosol generating system shown in FIG. 7 may be the same as or similar to at least one of the components of the aerosol generating system of FIG. 6, and thus redundant descriptions thereof are omitted below. It will be appreciated that some components and structures may be replaced, added, or omitted as will be readily understood by one of skilled in the art with reference to the following drawings and description.

The aerosol generating device 1 may generate an aerosol by heating the aerosol generating article 5 accommodated in the cavity 100a in an induction heating method. The induction heating method may refer to a method of generating heat of a magnetic body by applying an alternating magnetic field whose direction periodically changes to the magnetic body that generates heat by an external magnetic field.

When the alternating magnetic field is applied to the magnetic body, energy loss due to eddy current loss and hysteresis loss may occur in the magnetic body, and the lost energy may be emitted from the magnetic body as thermal energy. As the amplitude or frequency of the alternating magnetic field applied to the magnetic body increases, more heat energy may be emitted from the magnetic body. The aerosol generating device 1 may release thermal energy from the magnetic body by applying the alternating magnetic field to the magnetic body, and may transfer the thermal energy emitted from the magnetic body to the aerosol generating article 5.

To this end, the heater 140 may include a susceptor 140a and a coil 140b.

The susceptor 140a is a magnetic body that generates heat by a magnetic field. The susceptor 140a may be disposed inside the aerosol generating device main body 100, and may be disposed to surround the aerosol generating article 5 accommodated in the cavity 100a. In this case, the susceptor 140a may be formed in a shape of an entirely hollow cylinder, but the shape is not limited thereto.

In a modified embodiment, the susceptor 140a may be disposed inside the aerosol generating article 5 accommodated in the cavity 100a. In this case, the susceptor 140a may be included in the aerosol generating article 5 in the shape of a piece, a flake, or a strip.

At least a part of the susceptor 140a may include a ferromagnetic substrate. For example, the susceptor 140a may include metal or carbon. The susceptor 140a may include at least one of ferrite, a ferromagnetic alloy, stainless steel, and aluminum (Al). In addition, the susceptor 140a may include at least one of ceramic such as graphite, molybdenum, silicon carbide, niobium, nickel alloy, metal film, zirconia, etc., transition metal such as nickel (Ni), cobalt (Co), etc., or metalloid such as boron (B) or phosphorus (P).

The coil 140b may generate heat of the susceptor 140a by applying the alternating magnetic field to the susceptor 140a. The coil 140b may be disposed to surround an outer side of the susceptor 140a. The battery 120 may include a battery unit that supplies DC to the coil 140b and a conversion unit that converts DC supplied from the battery unit into AC supplied to the coil 140b.

The sensor module 150 may recognize the identification material 10 of the aerosol generating article 5 accommodated in the cavity 100a, and the control unit 110 may control power supply to the coil 140b based on the information of the aerosol generating article 5.

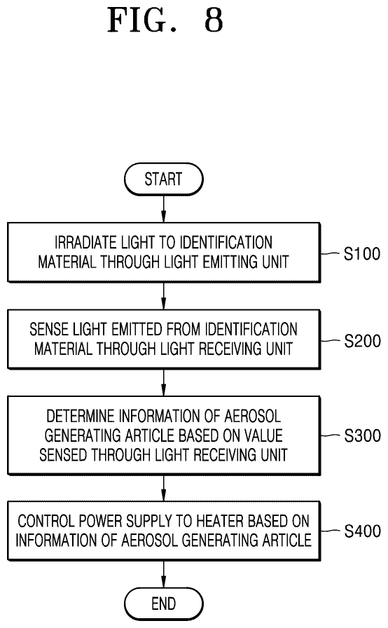

FIG. 8 is a flowchart in which an aerosol generating system controls power supply to a heater by determining information of an aerosol generating article according to an embodiment. The description of at least one of components of the aerosol generating system of FIG. 8 is the same as or similar to the description mentioned above, and thus redundant descriptions are omitted.

Referring to FIG. 8, a method of operating the aerosol generating system according to an embodiment may include four operations.

First, the control unit of the aerosol generating device may irradiate light to the identification material through the light emitting unit in operation S100.

In an embodiment, when the insertion of the aerosol generating article is detected, a control unit may irradiate light having a certain wavelength through a light emitting unit. For example, the aerosol generating device may include an insertion detection sensor such as an inductive sensor, a capacitance sensor, or a pressure sensor, and when the insertion of the aerosol generating article is detected through the insertion detection sensor, the control unit may irradiate the light with the certain wavelength through the light emitting unit.

In another embodiment, when a user input to the aerosol generating device is received, the control unit may irradiate the light with the certain wavelength through the light emitting unit. For example, the aerosol generating device may include a physical button that allows a user to select the state (e.g., power on/off) of the device, and when a user input to the physical button is received, the control unit may irradiate the light with the certain wavelength through the light emitting unit.

In an embodiment, a wavelength of the light with the certain wavelength through the light emitting unit may correspond to a first wavelength range. In this regard, the first wavelength range may refer to a wavelength range of light capable of exciting an identification material, and thus may be preset to correspond to the identification material. For example, in order to identify an aerosol generating article including an identification material excited at a wavelength of about 365 nm, the first wavelength range may be preset to a range of about 340 nm to about 375 nm.

In an embodiment, the first wavelength range capable of exciting the identification material may include at least one of about 250 nm to about 260 nm, about 300 nm to about 340 nm, about 350 nm to about 390 nm, about 600 nm to about 900 nm, or about 930 nm to about 990 nm.

For example, when the first wavelength range includes a wavelength range of about 300 nm to about 340 nm, the control unit may irradiate ultraviolet light of about 320 nm to the identification material of the aerosol generating article through the light emitting unit.

For another example, when the first wavelength range includes a wavelength range of about 340 nm to 375 nm, the control unit may irradiate ultraviolet light of about 365 nm to the identification material of the aerosol generating article through the light emitting unit.

For another example, when the first wavelength range includes a wavelength range of about 930 nm to 990 nm, the control unit may irradiate infrared ray of about 980 nm to the identification material of the aerosol generating article through the light emitting unit.

Next, the control unit may sense light emitted from the identification material through the light receiving unit in operation S200.

In an embodiment, a wavelength of the light sensed through the light receiving unit may correspond to a second wavelength range. In this regard, the second wavelength range may refer to a wavelength range of light emitted from the excited identification material when the light in the first wavelength range is irradiated. For example, the identification material may emit light in the range of about 1000 nm to about 1020 nm when excited at a wavelength of about 320 nm, and the control unit may determine a wavelength range of about 1000 nm to about 1020 nm obtained through the light receiving unit as the second wavelength range emitted from the identification material.

In an embodiment, the control unit may receive an ADC value from the light receiving unit and sense the light emitted from the identification material. In this regard, when the light is received from the identification material, the light receiving unit may obtain an analog signal, and the ‘ADC value’ may refer to a digital value converted from the analog signal such that the control unit may recognize a signal obtained by the light receiving unit. For example, based on the ADC value received from the light receiving unit, the control unit may determine the wavelength range of the light emitted from the identification material.

Next, the control unit may determine information of the aerosol generating article based on the sensing value sensed through the light receiving unit in operation S300. In this regard, the information of the aerosol generating article may include a type of the aerosol generating article, whether the aerosol generating article is forged or altered, etc.

In an embodiment, the control unit may determine the information of the aerosol generating article based on different sensing values sensed according to the type of the identification material.

For example, the identification material may include a first identification material emitting light of about 1012 nm and a second identification material emitting light of about 700 nm.

In this regard, when the sensing value sensed through the light receiving unit corresponds to a wavelength value (about 1012 nm) emitted from the first identification material, the control unit may determine that the aerosol generating article is a first type of aerosol generating article including the first identification material.

Alternatively, when the sensing value sensed through the light receiving unit corresponds to a wavelength value (about 700 nm) emitted from the second identification material, the control unit may determine that the aerosol generating article is a second type of aerosol generating article including the second identification material.

A difference between the wavelength value emitted from the first identification material and the wavelength value emitted from the second identification material may be about 15 nm or more. When the difference between the wavelength value emitted from the first identification material and the wavelength value emitted from the second identification material are less than about 15 nm, the accuracy of the control unit identifying the type of the identification material may be degraded. Here, the wavelength value emitted from the first identification material and the wavelength value emitted from the second identification material may each refer to the DWL. For example, the difference between the wavelength value emitted from the first identification material and the wavelength value emitted from the second identification material may be about 30 nm or more, about 50 nm or more, or about 100 nm or more.

In an embodiment, the control unit may determine the information of the aerosol generating article based on different sensing values sensed according to different concentrations of the identification material.

For example, the identification material may include the same type of material, but may include a first concentration of identification material having a first concentration (e.g., 20%) and a second concentration of identification material having a second concentration (e.g., 30%).

In this regard, when the sensing value sensed through the light receiving unit exceeds a first threshold value, the control unit may determine that the aerosol generating article is the first type of aerosol generating article including the first concentration of the identification material.

Alternatively, when the sensing value sensed through the light receiving unit exceeds a second threshold value greater than the first threshold value, the control unit may determine that the aerosol generating article is the second type of aerosol generating article including the second concentration of the identification material.

Next, the control unit 110 may control power supply to the heater based on the information of the aerosol generating article in operation S400.

In an embodiment, the control unit may control power supply to the heater based on the type of the aerosol generating article. For example, when it is determined that the type of aerosol generating article is the first type of aerosol generating article, the control unit may control power supply to the heater based on a first temperature profile set for the first type of aerosol generating article. For another example, when it is determined that the type of aerosol generating article is the second type of aerosol generating article, the control unit may control power supply to the heater based on a second temperature profile set for the second type of aerosol generating article. In this regard, the preset first temperature profile and the preset second temperature profile may be different from each other.

In an embodiment, the control unit may control power supply to the heater based on whether the aerosol generating article is forged or altered. For example, when it is determined that the aerosol generating article is a genuine article, the control unit may control the power supply to the heater based on a temperature profile set for the aerosol generating article 5. For another example, when it is determined that the aerosol generating article is a forged or altered article, the control unit may not supply power to the heater or may cut off the power being supplied.

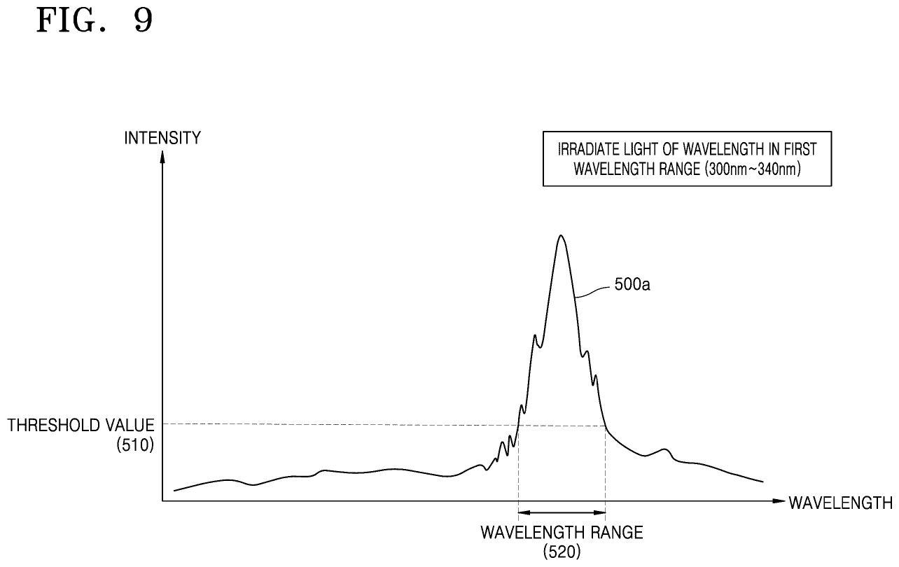

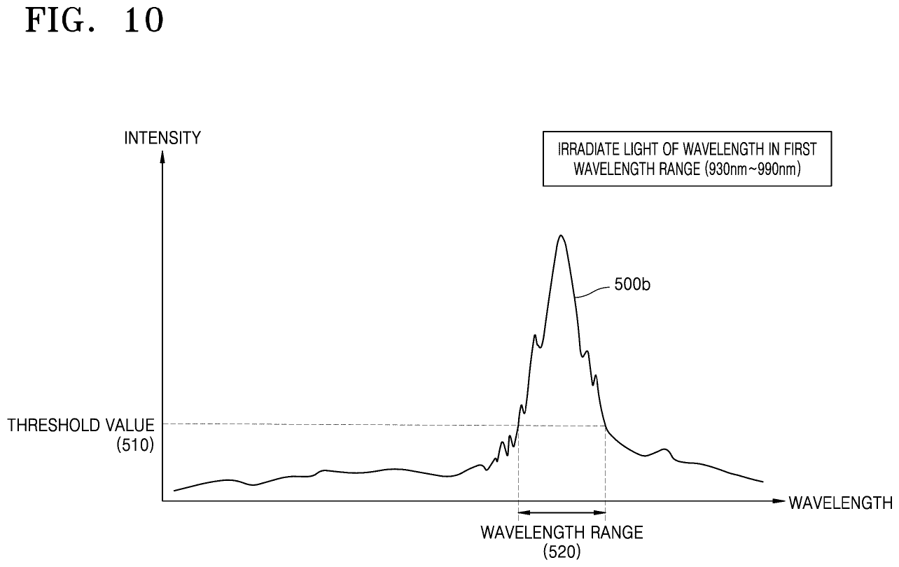

FIG. 9 is an example of a graph of a wavelength emitted from a first identification material when a wavelength in a first wavelength range is irradiated. FIG. 10 is an example of a graph of a wavelength emitted from a second identification material when the wavelength in the first wavelength range is irradiated.

Referring to FIG. 9, the first identification material included in an aerosol generating article may emit light having a certain wavelength range by light having the first wavelength range emitted from a light emitting unit. In this regard, the first wavelength range may be from about 300 nm to about 340 nm.

In an embodiment, a control unit of an aerosol generating device may determine a wavelength range 520 exceeding a threshold value 510 as a second wavelength range in a first graph 500a, which is a graph of a wavelength emitted from the first identification material. For example, the control unit may receive a sensing value corresponding to the wavelength range 520 through a light receiving unit, and the second wavelength range 520 may be from about 1000 nm to about 1020 nm.

Referring to FIG. 10, the second identification material included in the aerosol generating article may emit light having a certain wavelength range by light having the first wavelength range emitted from the light emitting unit. In this regard, the first wavelength range may be from about 930 nm to about 990 nm.

In an embodiment, the control unit 110 of the aerosol generating device may determine the wavelength range 520 exceeding the threshold value 510 as the second wavelength range in a second graph 500b, which is a graph of a wavelength emitted from the second identification material. For example, the control unit may receive a sensing value corresponding to the wavelength range 520 through the light receiving unit, and the second wavelength range 520 may be from about 1000 nm to about 1020 nm.

The first graph 500a of FIG. 9 and the second graph 500b of FIG. 10 are shown in the same shape for convenience of description, but are not limited thereto. For example, the first graph 500a of FIG. 9 and the second graph 500b of FIG. 10 may have partially similar wavelength ranges exceeding the threshold value 510, but may have different overall graph shapes.

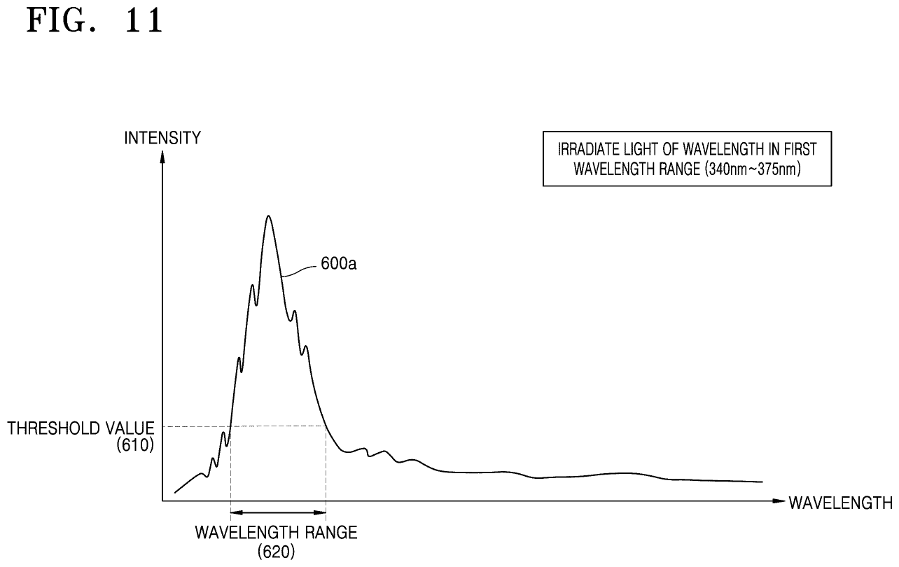

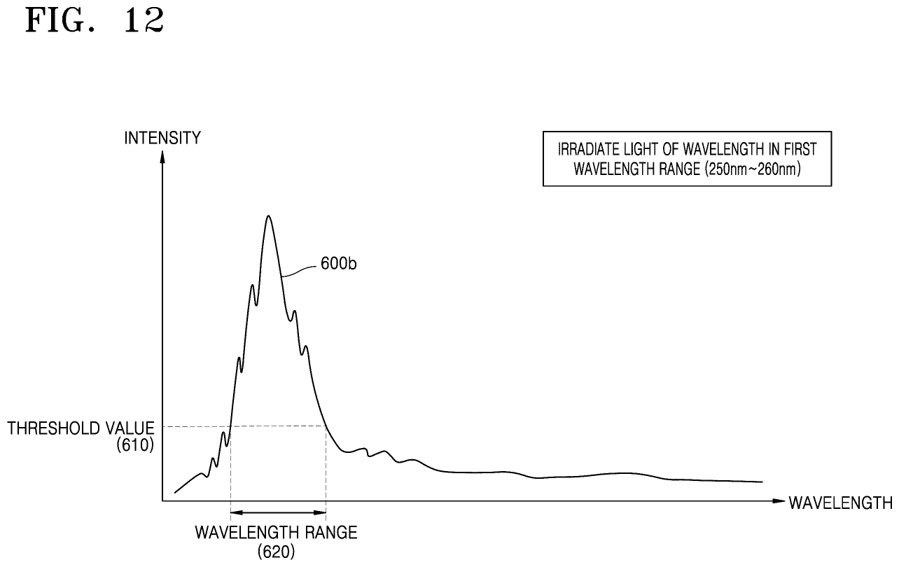

FIG. 11 is an example of a graph of a wavelength emitted from a third identification material when a wavelength in a first wavelength range is irradiated. FIG. 12 is an example of a graph of a wavelength emitted from the third identification material when the wavelength in the first wavelength range is irradiated.

Referring to FIG. 11, the third identification material included in the aerosol generating article may emit light having a certain wavelength range by light having the first wavelength range emitted from a light emitting unit. In this case, the first wavelength range may be from about 340 nm to about 375 nm.

In an embodiment, a control unit of an aerosol generating device may determine a wavelength range 620 exceeding a threshold value 610 as a second wavelength range in a third graph 600a, which is a graph of a wavelength emitted from the third identification material. For example, the control unit may receive a sensing value corresponding to the wavelength range 620 through a light receiving unit, and the wavelength range 620 which is the second wavelength range may be a part of a wavelength range of about 400 nm to about 750 nm.

For example, when the wavelength range 620 is between about 450 nm and about 490 nm, the control unit may determine that the sensing value sensed through the light receiving unit corresponds to ‘blue’, and determine that the aerosol generating article in which the identification material is expressed as ‘blue’ is a first type of aerosol generating article.

For another example, when the wavelength range 620 is from about 490 nm to about 570 nm, the control unit may determine that the sensing value sensed through the light receiving unit corresponds to ‘green’, and determine that the aerosol generating article in which the identification material is expressed as ‘green’ is a second type of aerosol generating article.

For another example, when the wavelength range 620 is from about 630 nm to about 750 nm, the control unit may determine that the sensing value sensed through the light receiving unit corresponds to ‘red’, and determine that the aerosol generating article in which the identification material is expressed as ‘red’ is a third type of aerosol generating article.

Referring to FIG. 12, the third identification material included in the aerosol generating article may emit light having a certain wavelength range by light having the first wavelength range emitted from the light emitting unit. In this regard, the first wavelength range may be from about 250 nm to about 260 nm. That is, the third identification material may be excited not only in a wavelength range of about 350 nm to about 390 nm, but also in a wavelength range of about 250 nm to about 260 nm.

In an embodiment, the control unit of the aerosol generating device may determine the wavelength range 620 exceeding the threshold value 610 as the second wavelength range in a fourth graph 600b, which is a graph of a wavelength emitted from the third identification material. For example, the control unit may receive a sensing value corresponding to the wavelength range 620 through the light receiving unit, and the wavelength range 620 which is the second wavelength range may be a part of a wavelength range of about 400 nm to about 750 nm.

The third graph 600a of FIG. 11 and the fourth graph 600b of FIG. 12 are shown in the same shape for convenience of description, but are not limited thereto. For example, the third graph 600a of FIG. 11 and the fourth graph 600b of FIG. 12 may have partially similar wavelength ranges exceeding the threshold value 610, but may have different overall graph shapes.

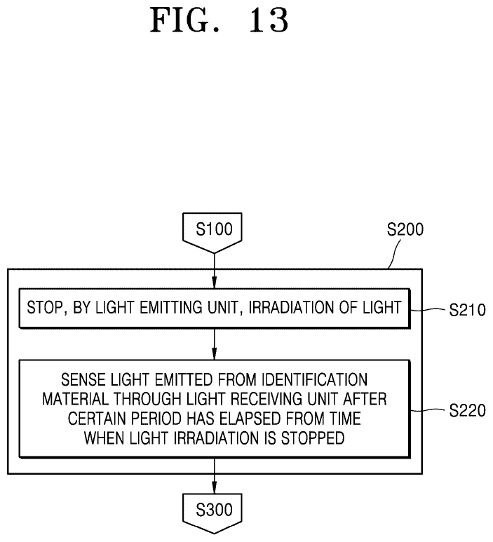

FIG. 13 is a flowchart of another specific example in which an aerosol generating system determines information of an aerosol generating article according to an embodiment. FIG. 13 is a flowchart further specifying the operation of FIG. 8, and the description of at least one of components of the aerosol generating system of FIG. 13 is the same as or similar to the description mentioned above, and thus redundant descriptions are omitted.

Referring to FIG. 13, operation S200 may include operations S210 and S220.

First, a control unit of an aerosol generating device may stop irradiating light to an identification material through the light emitting unit in operation S210, after irradiating the light to the identification material through a light emitting unit.

For example, the state of the identification material may change from a ground state to an excited state when a first time elapses from the time when light is irradiated from the light emitting unit. In this regard, the ‘first time’ may refer to a time in which no further change in the state of the material occurs after the identification material is excited when light is absorbed. The control unit may irradiate light to the identification material through the light emitting unit during the first time, and stop irradiating light to the identification material through the light emitting unit when the first time elapses.

Next, in operation S220, the control unit may sense the light emitted from the identification material through a light receiving unit after a second time has elapsed from the time when the light irradiation of the light emitting unit to the identification material is stopped. In this regard, the ‘second time’ may refer to a time it takes for the light irradiated from the light emitting unit to be not sensed by the light receiving unit after the light irradiation from the light emitting unit is stopped.

In other words, the light receiving unit needs to focus on sensing the light emitted from the identification material, but some noise may be included in the sensing value when the light irradiated from the light emitting unit is sensed together with the light receiving unit.

However, the identification material according to the disclosure may emit light (i.e., residual light) for a certain time even when the light irradiated from the light emitting unit is blocked. Thus, the control unit may sense the light emitted from the identification material through the light receiving unit after the second time has elapsed from the time when the light irradiation of the light emitting unit is stopped.

In an embodiment, the control unit may sense light emitted from the identification material through the light receiving unit after a time of about 200 μs to about 2000 μs has elapsed from the time when the light irradiation of the light emitting unit to the identification material is stopped.

For example, when the identification material is a first type of material that emits light for a relatively long time even after the light irradiated from the light emitting unit is blocked or a first concentration material, the control unit may sense the light emitted from the identification material through the light receiving unit after a time of about 500 μs to about 2000 μs.

For example, when the identification material is a second type of material that emits light for a relatively short time after the light irradiated from the light emitting unit is blocked, or a second concentration of material lower than the first concentration, the control unit may sense the light emitted from the identification material through the light receiving unit after a time of about 200 μs to about 500 μs.

Meanwhile, in another embodiment, the light emitting unit may emit light and simultaneously the light receiving unit may receive light emitted by the identification material. Accordingly, it is possible to shorten the time for a sensor module to recognize the identification material.

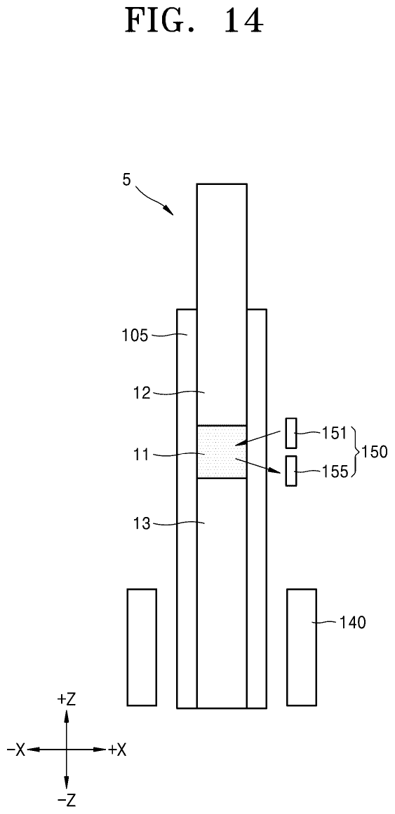

FIGS. 14 to 18 are schematic conceptual diagrams of an aerosol generating system for explaining the arrangement of a sensor module according to an embodiment.

In FIGS. 14 to 18, the aerosol generating article 5 accommodated in the cavity 100a may be divided into a first region 11 in which the identification material 10 is disposed, a second region 12 upstream of the first region 11, and a third region 13 downstream of the first region 11. Here, “upstream” and “downstream” may be determined based on a direction in which air flows when a user inhales an aerosol by using the aerosol generating article 5. For example, when the user inhales the aerosol by using the aerosol generating article 5 shown in FIG. 14, air may move from a lower portion of the aerosol generating article 5 to an upper portion thereof in FIG. 5.

Referring to FIGS. 6 and 14, the aerosol generating device 1 according to an embodiment may further include an inner wall 105 defining the cavity 100a. The sensor module 150 may include the light emitting unit 151 and the light receiving unit 155. The light emitting unit 151 may emit light having a first wavelength toward a first region 11 of the aerosol generating article 5 through a transparent region of the inner wall 105. The light receiving unit 155 may receive light of a second wavelength emitted from the identification material 10 of the first region 11 through the transparent region of the inner wall 105. The control unit 110 may determine information of the aerosol generating article 5 based on a sensing value sensed through the light receiving unit 155, and control power supply to the heater 140 based on the determined information of the aerosol generating article 5.

The inner wall 105 may include the transparent region through which light is transmitted in at least one region. For the sensing accuracy of the sensor module 150, the transparent region of the inner wall 105 may include a material having low reflectivity and refractive index and high transmittance with respect to light.

Meanwhile, an aerosol generating article 5 may be accommodated in the cavity 100a of the aerosol generating device 1, and the heater 140 heating the accommodated aerosol generating article 5 may be disposed adjacent thereto.

The inner wall 105 may be continuously exposed to a high-temperature environment when the heater 140 performs a heating operation. Therefore, the inner wall 105 may deteriorate while being continuously exposed to a high temperature, and as a result, the transparency of the transparent region may be lowered or the transparent region may be discolored. In addition, in the inner wall 105, the transparency of the transparent region may be lowered or the transparent region may be discolored due to droplets generated in the aerosol generating article 5.

When the transparency of the transparent region of the inner wall 105 is lowered, the intensity of light of the second wavelength received by the light receiving unit 155 may be weakened.

In addition, when the transparent region of the inner wall 105 is discolored, light of the second wavelength received by the light receiving unit 155 may be modulated or changed in color. For example, when the light receiving unit 155 includes a color sensor, the light of the second wavelength is red as a wavelength of a visible light band, and the transparent region of the inner wall 105 is discolored to green, the light receiving unit 155 may sense the light emitted by the identification material 10 of the aerosol generating article 5 as yellow light rather than red light. In other words, as the transparent region of the inner wall 105 is discolored, light of the second wavelength may be discolored while functioning as a cellophane or color filter. When the light of the second wavelength is modulated or discolored due to the discoloration of the transparent region of the inner wall 105, there may be a problem that the control unit 110 may incorrectly determine information of the aerosol generating article 5 inserted into the cavity 100a.

The sensor module 150 according to an embodiment may include a plurality of light receiving units.

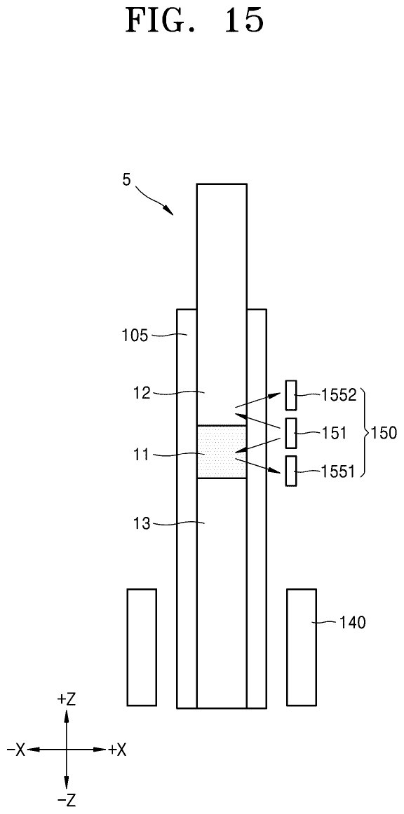

Referring to FIGS. 6 and 15, the sensor module 150 may include the light emitting unit 151, a first light receiving unit 1551, and a second light receiving unit 1552. The light emitting unit 151 may emit light having a first wavelength toward the first region 11 and the second region 12 of the aerosol generating article 5 through the transparent region of the inner wall 105. The first light receiving unit 1551 may receive the light of the second wavelength emitted from the identification material 10 of the first region 11 through the transparent region of the inner wall 105. The second light receiving unit 1552 may receive light reflected from the second region 12 through the transparent region of the inner wall 105. The light reflected from the second region 12 through the transparent region of the inner wall 105 may be the first wavelength.

The control unit 110 may determine the information of the aerosol generating article 5 based on a first sensing value sensed through the first light receiving unit 1551 and a second sensing value sensed through the second light receiving unit 1552.

Specifically, the control unit 110 may calculate the degree of deterioration of the transparent region of the inner wall 105 based on the second sensing value sensed through the second light receiving unit 1552.

For example, the control unit 110 may compare the second sensing value sensed through the second light receiving unit 1552 with an initial value previously stored in the memory 130 to calculate the transmittance of the transparent region of the inner wall 105. The initial value may be calculated through an experimental measurement in the manufacturing stage of the aerosol generating device 1, and may be previously stored in the memory 130.

In another example, the control unit 110 may calculate an RGB color value of the transparent region of the inner wall 105 from the second sensing value sensed through the second light receiving unit 1552.

In an embodiment, the control unit 110 may adjust the amount of light output by the light emitting unit 151 based on the transmittance of the transparent region calculated through the second sensing value. When the transmittance of the transparent region of the inner wall 105 is lowered, the control unit 110 may compensate for the intensity of light of the second wavelength received by the first light receiving unit 1551, by increasing the amount of light emitted by the light emitting unit 151.

In an embodiment, the control unit 110 may correct the first sensing value based on the RGB color value of the transparent region of the inner wall 105 calculated through the second sensing value, and determine information of the aerosol generating article 5 based on the corrected first sensing value. For example, when the RGB color value of the transparent region of the inner wall 105 is calculated as green and the first sensing value corresponds to red light, the control unit 110 may determine the information of the aerosol generating article 5 based on a value obtained by subtracting an RGB color value of the second sensing value from an RGB color value of the first sensing value. In other words, the control unit 110 may generate a corrected first sensing value by excluding the second sensing value from the RGB color value of the first sensing value, and determine information of the aerosol generating article 5 based on the corrected first sensing value. Here, an RGB color value of the corrected first sensing value may be yellow.

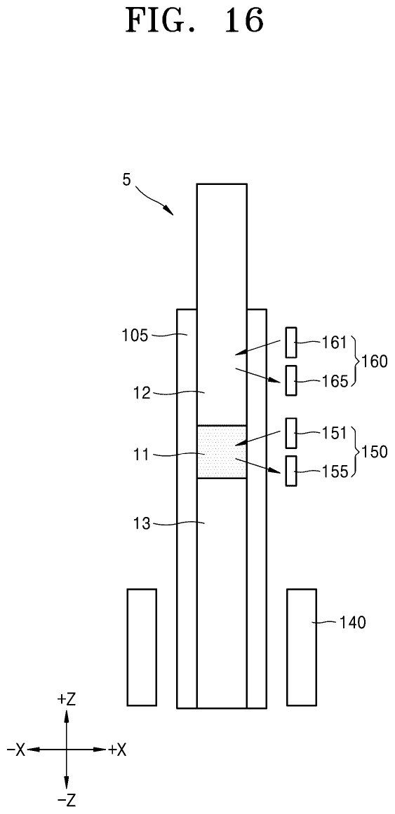

Referring to FIGS. 6 and 16, in an embodiment, the sensor module may be configured to include a first sensor module 150 and a second sensor module 160.

The first sensor module 150 may include the first light emitting unit 151 and the first light receiving unit 155. The second sensor module 160 may include a second light emitting unit 161 and a second light receiving unit 165.

The first light emitting unit 151 may emit light having the first wavelength toward the first region 11 of the aerosol generating article 5 through the transparent region of the inner wall 105. The first light receiving unit 155 may receive light of the second wavelength emitted from the identification material 10 of the first region 11 through the transparent region of the inner wall 105.

The second light emitting unit 161 may emit light having the first wavelength toward the first region 11 of the aerosol generating article 5 through the transparent region of the inner wall 105. The second light receiving unit 165 may receive light reflected from the second region 12 through the transparent region of the inner wall 105.

In an embodiment, the first light emitting unit 151 may emit ultraviolet light, and the second light emitting unit 161 may emit white visible light. In an embodiment of FIG. 16, compared to FIG. 15, because a plurality of light emitting units are configured, a wavelength of light irradiated to the first region 11 may be set to be different from a wavelength of light irradiated to the second region 12.

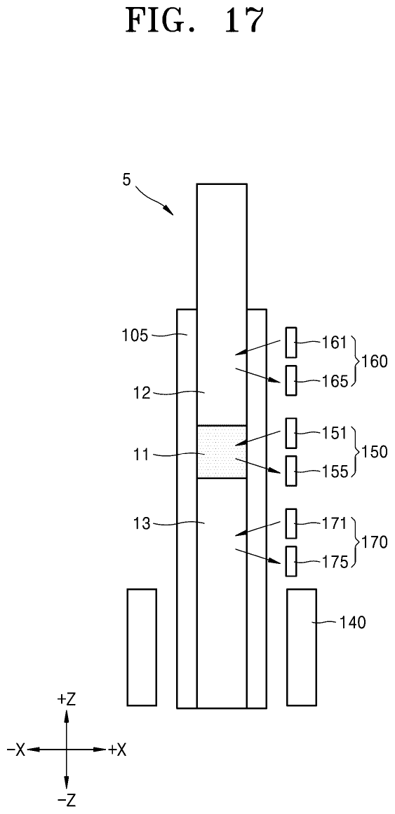

Referring to FIGS. 6 and 17, in an embodiment, three sensor modules may include the first sensor module 150, the second sensor module 160, and a third sensor module 170.

The first sensor module 150 may include the first light emitting unit 151 and the first light receiving unit 155. The second sensor module 160 may include the second light emitting unit 161 and the second light receiving unit 165. The third sensor module 170 may include a third light emitting unit 171 and a third light receiving unit 175.

The first light emitting unit 151 may emit light having the first wavelength toward the first region 11 of the aerosol generating article 5 through the transparent region of the inner wall 105. The first light receiving unit 155 may receive light of the second wavelength emitted from the identification material 10 of the first region 11 through the transparent region of the inner wall 105.

The second light emitting unit 161 may emit light having the first wavelength toward the first region 11 of the aerosol generating article 5 through the transparent region of the inner wall 105. The second light receiving unit 165 may receive light reflected from the second region 12 through the transparent region of the inner wall 105.

The third light emitting unit 171 may emit light having the first wavelength toward the third region 13 of the aerosol generating article 5 through the transparent region of the inner wall 105. The third light receiving unit 175 may receive light reflected from the third region 13 through the transparent region of the inner wall 105.

The control unit 110 may determine the information of the aerosol generating article 5 based on the first sensing value sensed through the first light receiving unit 155, the second sensing value sensed through the second light receiving unit 165, and a third sensing value sensed through the third light receiving unit 175.

Specifically, the control unit 110 may calculate the degree of deterioration of the transparent region of the inner wall 105 based on an average value of the second sensing value sensed through the second light receiving unit 165 and the third sensing value sensed through the third light receiving unit 175. For example, the control unit 110 may calculate the transmittance of the transparent region of the inner wall 105 by comparing the average value of the second sensing value sensed through the second light receiving unit 165 and the third sensing value sensed through the third light receiving unit 175 with an initial value previously stored in the memory 130. The initial value may be calculated through an experimental measurement in the manufacturing stage of the aerosol generating device 1, and may be previously stored in the memory 130. In another example, the control unit 110 may calculate the RGB color value of the transparent region of the inner wall 105 from the average value of the second sensing value sensed through the second light receiving unit 165 and the third sensing value sensed through the third light receiving unit 175.

In an embodiment, the control unit 110 may adjust the amount of light emitted by the light emitting unit based on the calculated transmittance of the transparent region. When the transmittance of the transparent region of the inner wall 105 is lowered, the control unit 110 may compensate for the intensity of light of the second wavelength received by the light receiving unit, by increasing the amount of light emitted by the light emitting unit.

In an embodiment, the control unit 110 may correct the first sensing value based on the RGB color value of the transparent region of the inner wall 105 calculated through the second sensing value and the third sensing value, and determine the information of the aerosol generating article 5 based on the corrected first sensing value. For example, when the RGB color value of the transparent region of the inner wall 105 is calculated as green and the first sensing value corresponds to red light, the control unit 110 may determine the information of the aerosol generating article 5 based on a value obtained by subtracting an RGB color value corresponding to the average value of the second sensing value and the third sensing value from the RGB color value of the first sensing value. In other words, the control unit 110 may generate the corrected first sensing value by excluding the average value of the second sensing value and the third sensing value from the RGB color value of the first sensing value, and may determine the information of the aerosol generating article 5 based on the corrected first sensing value. Here, an RGB color value of the corrected first sensing value may be yellow.

The degree of deterioration of the inner wall 105 may vary depending on a location due to a distance from the heater 140 and a difference in the amount of droplets. For example, the degree of deterioration of the inner wall 105 adjacent to the third region 13 of the aerosol generating article 5 accommodated in the cavity 100a is closer to the heater 140, and thus may be greater than the degree of deterioration of the inner wall 105 adjacent to the second region 12. The degree of deterioration of the inner wall 105 adjacent to the first region 11 may be close to an average of the degree of deterioration of the inner wall 105 adjacent to the second region 12 and the degree of deterioration of the inner wall 105 adjacent to the third region 13. Therefore, the control unit 110 may calculate the degree of deterioration of the transparent region of the inner wall 105 through the average value of the second sensing value and the third sensing value.

In an embodiment, the first light emitting unit 151 may emit ultraviolet ray, and the second light emitting unit 161 and the third light emitting unit 171 may emit white visible light.

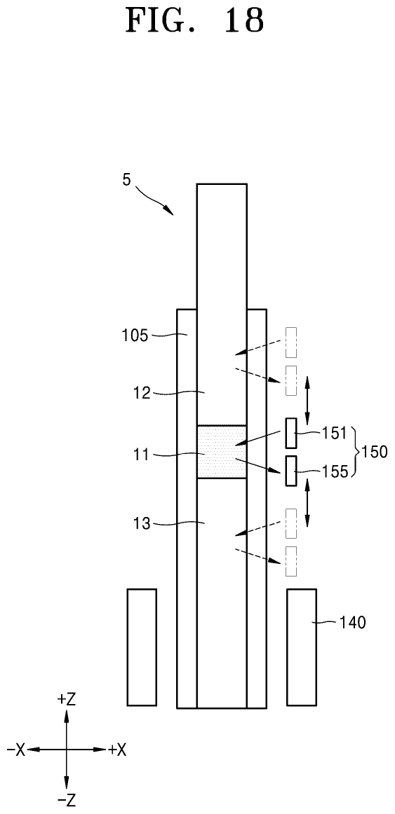

Referring to FIGS. 6 and 18, in an embodiment, the sensor module 150 may be movably disposed on a main body of the aerosol generating device 1 in a direction in which the cavity 100a extends. Even though the identification material 10 is not located at a certain position in a longitudinal direction of the aerosol generating article 5, the sensor module 150 may recognize the identification material 10. Accordingly, the degree of freedom of work of placing the identification material 10 on the aerosol generating article 5 may be improved.

The sensor module 150 may be disposed to be movable in a manner using a motor and a gear, but is not limited thereto. For example, the sensor module 150 may be moved by the control of the control unit 110. In another example, the sensor module 150 may be disposed to be movable based on an input signal of a user.

The sensor module 150 may be movably disposed to at least one of a first position corresponding to the first region 11, a second position corresponding to the second region 12, or a third position corresponding to the third region 13.

The light emitting unit 151 may emit light having the first wavelength toward the first region 11 of the aerosol generating article 5 through the transparent region of the inner wall 105 at the first position. The light receiving unit 155 may receive light of the second wavelength emitted from the identification material 10 of the first region 11 through the transparent region of the inner wall 105 at the first position.

The light emitting unit 151 may emit light having the first wavelength toward the second region 12 of the aerosol generating article 5 through the transparent region of the inner wall 105 at the second position. The light receiving unit 155 may receive light reflected from the second region 12 through the transparent region of the inner wall 105 at the second position.

The light emitting unit 151 may emit light having the first wavelength toward the third region 13 of the aerosol generating article 5 through the transparent region of the inner wall 105 at the third position. The light receiving unit 155 may receive light reflected from the third region 13 through the transparent region of the inner wall 105 at the third position.

In an embodiment, the control unit 110 may determine the information of the aerosol generating article 5 based on a first sensing value sensed at the first position and a second sensing value sensed at the second position through the sensor module 150.

The description of the control unit 110 determining the information of the aerosol generating article 5 based on the first sensing value and the second sensing value is omitted because it is redundant with the description given with reference to FIGS. 15 and 16.

In an embodiment, the control unit 110 may determine the information of the aerosol generating article 5 based on the first sensing value sensed at the first position, the second sensing value sensed at the second position, and a third sensing value sensed at the third position through the sensor module 150.

The description of the control unit 110 determining the information of the aerosol generating article 5 based on the first sensing value, the second sensing value, and the third sensing value is omitted because it is redundant with the description given with reference to FIG. 17.

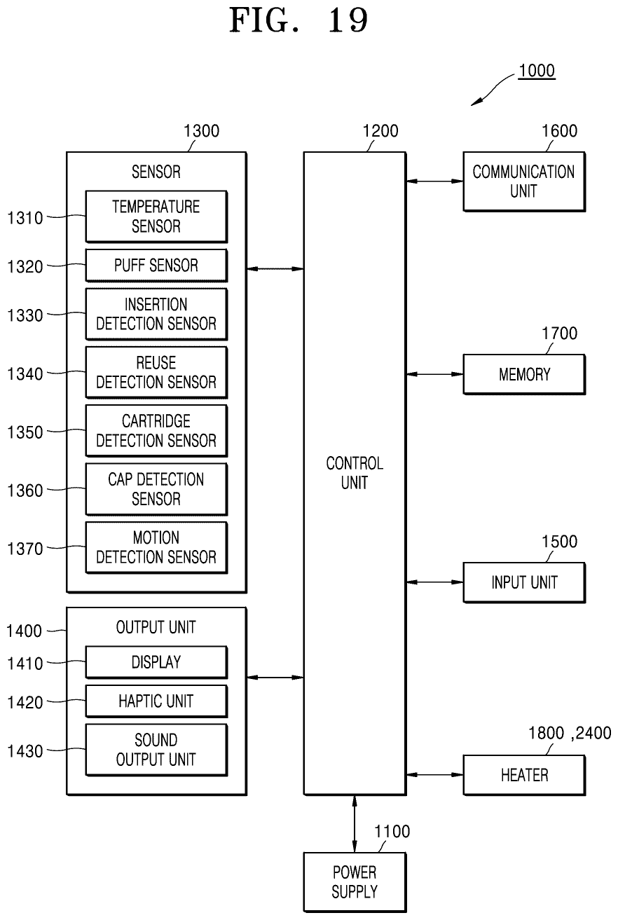

FIG. 19 is a block diagram of an aerosol generating device according to an embodiment.

An aerosol generating device 1000 may include a power supply 1100, a control unit 1200, a sensor 1300, an output unit 1400, an input unit 1500, a communication unit 1600, a memory 1700, and one or more heaters 1800 and 2400. However, an internal structure of the aerosol generating device 1000 is not limited to that shown in FIG. 19. In other words, according to the design of the aerosol generating device 1000, one of ordinary skill in the art related to the present embodiment that some of the components shown in FIG. 19 may be omitted or new components may be added

The sensor 1300 may detect a state of the aerosol generating device 1000 or a state around the aerosol generating device 1000 and transmit detected information to the control unit 1200. Based on the detected information, the control unit 1200 may control the aerosol generating device 1000 to perform various functions such as control of operations of the cartridge heater 2400 and/or the heater 1800, a restriction on smoking, determination of whether an aerosol generating article and/or a cartridge 19 are inserted, and a notification display.

The sensor 1300 may include at least one of a temperature sensor 1310, a puff sensor 1320, an insertion detection sensor 1330, a reuse detection sensor 1340, a cartridge detection sensor 1350, a cap detection sensor 1360, or a motion detection sensor 1370.

The temperature sensor 1310 may detect a temperature at which the cartridge heater 2400 and/or the heater 1800 are heated. The aerosol generating device 1000 may include a separate temperature sensor detecting the temperatures of the cartridge heater 2400 and/or the heater 1800, or the cartridge heater 2400 and/or the heater 1800 may operate as temperature sensors.

The temperature sensor 1310 may output a signal corresponding to the temperature of the cartridge heater 2400 and/or the heater 1800. For example, the temperature sensor 1310 may include a resistor element whose resistance value changes in correspondence to a change in the temperature of the cartridge heater 2400 and/or the heater 1800. The temperature sensor 1310 may be implemented by a thermistor, which is an element using a property of changing resistance according to temperature. In this regard, the temperature sensor 1310 may output a signal corresponding to the resistance value of the resistor element as a signal corresponding to the temperature of the cartridge heater 2400 and/or the heater 1800. For example, the temperature sensor 1310 may include a sensor that detects a resistance value of the cartridge heater 2400 and/or the heater 1800. Here, the temperature sensor 1310 may output a signal corresponding to the resistance value of the cartridge heater 2400 and/or the heater 1800 as the signal corresponding to the temperature of the cartridge heater 2400 and/or the heater 1800.

The temperature sensor 1310 may be disposed around the power supply 1100 to monitor a temperature of the power supply 1100. The temperature sensor 1310 may be disposed adjacent to the power supply 1100. For example, the temperature sensor 1310 may be attached to one surface of a battery that is the power supply 1100. For example, the temperature sensor 1310 may be mounted on one surface of a printed circuit board (PCB).

The temperature sensor 1310 may be disposed inside an aerosol generating device main body to detect an internal temperature of the aerosol generating device main body.

The puff sensor 1320 may detect a user's puff based on various physical changes in an airflow path. The puff sensor 1320 may output a signal corresponding to the puff. For example, the puff sensor 1320 may include a pressure sensor. The puff sensor 1320 may output a signal corresponding to internal pressure of the aerosol generating device 1000. Here, the internal pressure of the aerosol generating device 1000 may correspond to the pressure of the airflow path through which a gas flows. The puff sensor 1320 may be disposed to correspond to the airflow path through which the gas flows in the aerosol generating device 1000.

The insertion detection sensor 1330 may detect insertion and/or removal of the aerosol generating article. The insertion detection sensor 1330 may detect a signal change due to the insertion and/or removal of the aerosol generating article. The insertion detection sensor 1330 may be installed around an insertion space. The insertion detection sensor 1330 may detect the insertion and/or removal of the aerosol generating article according to a change in a dielectric constant inside the insertion space. For example, the insertion detection sensor 1330 may be an inductive sensor and/or a capacitance sensor.

The inductive sensor may include at least one coil. The coil of the inductive sensor may be disposed adjacent to the insertion space. For example, when a magnetic field changes around the coil through which a current flows, characteristics of the current flowing through the coil may change according to Faraday's law of electromagnetic induction. Here, the characteristics of the current flowing through the coil may include a frequency of an alternating current, a current value, a voltage value, an inductance value, an impedance value, etc.

The inductive sensor may output a signal corresponding to the characteristics of the current flowing through the coil. For example, the inductive sensor may output a signal corresponding to an inductance value of the coil.

The capacitance sensor may include a conductor. The conductor of the capacitance sensor may be disposed adjacent to the insertion space. The capacitance sensor may output a signal corresponding to an ambient electromagnetic characteristic, e.g., a capacitance around the conductor. For example, when the aerosol generating article including a metal wrapper is inserted into the insertion space, the electromagnetic characteristic around the conductor may be changed by the wrapper of the aerosol generating article.

The reuse detection sensor 1340 may detect whether the aerosol generating article is reused. The reuse detection sensor 1340 may be a color sensor. The color sensor may detect a color of the aerosol generating article. The color sensor may detect a color of a part of the wrapper wrapping the outside of the aerosol generating article. The color sensor may detect a value with respect to an optical characteristic corresponding to a color of an object, based on light reflected from the object. For example, the optical characteristic may be a wavelength of light. The color sensor may be implemented as a single component with a proximity sensor or may be implemented as a separate component distinguished from the proximity sensor.

At least a part of the wrapper constituting the aerosol generating article may have a color changing by an aerosol. When the aerosol generating article is inserted into the insertion space, the reuse detection sensor 1340 may be disposed in correspondence to a location at which at least a part of the wrapper whose color changes by the aerosol is disposed. For example, before the aerosol generating article is used by a user, the color of at least a part of the wrapper may be a first color. In this regard, when at least a part of the wrapper is wetted by the aerosol while the aerosol generated by the aerosol generating device 1000 passes through the aerosol generating article, the color of at least a part of the wrapper may be changed to a second color. Meanwhile, the color of at least a part of the wrapper may be maintained in the second color after changing from the first color to the second color.

The cartridge detection sensor 1350 may detect mounting and/or removal of the cartridge 19. The cartridge detection sensor 1350 may be implemented by an inductance-based sensor, a capacitive sensor, a resistance sensor, a hall sensor (a hall IC) using a hall effect, etc.

The cap detection sensor 1360 may detect mounting and/or removal of a cap. When the cap is detached from the aerosol generating device main body, a part of the cartridge 19 and the aerosol generating device main body covered by the cap may be exposed to the outside. The cap detection sensor 1360 may be implemented by a contact sensor, a hall sensor (a hall IC), an optical sensor, etc.

The motion detection sensor 1370 may detect a motion of the aerosol generating device 1000. The motion detection sensor 1370 may be implemented as at least one of an acceleration sensor and a gyro sensor.

In addition to the temperature sensor 1310, the puff sensor 1320, the insertion detection sensor 1330, the reuse detection sensor 1340, the cartridge detection sensor 1350, the cap detection sensor 1360, and the motion detection sensor 1370 described above, the sensor 1300 may further include at least one of a humidity sensor, an atmospheric pressure sensor, a magnetic sensor, a global positioning system (GPS), or a proximity sensor. Functions of the respective sensors may be intuitively inferred from names thereof by one of ordinary skill in the art, and thus, detailed descriptions thereof may be omitted.

The output unit 1400 may output information about the state of the aerosol generating device 1000 and provide the information to the user. The output unit 1400 may include at least one of a display 1410, a haptic unit 1420, and a sound output unit 1430, but is not limited thereto. When the display 1410 and a touch pad form a layer structure to form a touch screen, the display 1410 may be used as an input device in addition to an output device.

The display 1410 may visually provide the user with information of the aerosol generating device 1000. For example, the information of the aerosol generating device 1000 may refer to various types of information such as a charging/discharging state of the power supply 1100 of the aerosol generating device 1000, a preheating state of the heater 1800, the insertion/removal state of the aerosol generating article and/or the cartridge 19, the mounting/removal state of the cap, and the restriction on use of the aerosol generating device 1000 (e.g., detection of an abnormal article), and the display 1410 may output the information to the outside. For example, the display 1410 may be in the form of a light emitting diode (LED) light emitting device. For example, the display 1410 may be a liquid crystal display (LCD) panel, an organic light emitting display (OLED) panel, etc.

The haptic unit 1420 may tactilely provide the user with the information of the aerosol generating device 1000 by converting an electrical signal into a mechanical stimulus or an electrical stimulus. For example, when initial power is supplied to the cartridge heater 2400 and/or the heater 1800 for a set time, the haptic unit 1420 may generate vibration corresponding to completion of initial preheating. The haptic unit 1420 may include a vibration motor, a piezoelectric element, or an electrical stimulation device.

The sound output unit 1430 may audibly provide the user with the information of the aerosol generating device 1000. For example, the sound output unit 1430 may convert the electrical signal into a sound signal and output the sound signal to the outside.

The power supply 1100 may supply power used to operate the aerosol generating device 1000. The power supply 1100 may supply power so that the cartridge heater 2400 and/or the heater 1800 may be heated. In addition, the power supply 1100 may supply power necessary for operations of the sensor 1300, the output unit 1400, the input unit 1500, the communication unit 1600, and the memory 1700, which are other components provided within the aerosol generating device 1000. The power supply 1100 may be a rechargeable battery or a disposable battery. For example, the power supply 1100 may be a lithium polymer (LiPoly) battery, but is not limited thereto.

Although not shown in FIG. 19, the aerosol generating device 1000 may further include a power protection circuit. The power protection circuit may be electrically connected to the power supply 1100 and may include a switching element.

The power protection circuit may cut off an electrical path with respect to the power supply 1100 according to a certain condition. For example, the power protection circuit may cut off the electrical path with respect to the power supply 1100 when a voltage level of the power supply 1100 is a first voltage or more corresponding to overcharging. For example, the power protection circuit may cut off the electrical path with respect to the power supply 1100 when the voltage level of the power supply 1100 is less than a second voltage corresponding to overdischarging.

The heater 1800 may be supplied with power from the power supply 1100 and heat a medium or an aerosol generating material within the aerosol generating article. Although not shown in FIG. 19, the aerosol generating device 1000 may further include a power conversion circuit (e.g., a DC/DC converter) that converts power of the power supply 1100 and supplies the converted power to the cartridge heater 2400 and/or the heater 1800. In addition, when the aerosol generating device 1000 generates an aerosol by an induction heating method, the aerosol generating device 1000 may further include a DC/AC converter that converts DC power of the power supply 1100 into AC power.

The control unit 1200, the sensor 1300, the output unit 1400, the input unit 1500, the communication unit 1600, and the memory 1700 may be supplied with power from the power supply 11 to perform functions. Although not shown in FIG. 19, the aerosol generating device 1000 may further include a power conversion circuit that converts power of the power supply 1100 and supplies the power to each of components, e.g., a low-dropout (LDO) circuit or a voltage regulator circuit. In addition, although not shown in FIG. 19, a noise filter may be provided between the power supply 1100 and the heater 1800. The noise filter may be a low pass filter. The low pass filter may include at least one inductor and a capacitor. A cutoff frequency of the low pass filter may correspond to a frequency of a high-frequency switching current applied from the power supply 1100 to the heater 1800. The low pass filter may prevent a high-frequency noise component from being applied to the sensor 1300, such as the insertion detection sensor 1330.

In an embodiment, the cartridge heater 2400 and/or the heater 1800 may include any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater 1800 may be implemented by a metal wire, a metal plate on which an electrically conductive track is disposed, or a ceramic heating element, but is not limited thereto.

In another embodiment, the heater 1800 may include an induction heating-type heater. For example, the heater 1800 may include a susceptor that generates heat through a magnetic field applied by a coil to heat an aerosol generating material.

The input unit 1500 may receive information input from the user or output the information to the user. For example, the input unit 1500 may be a touch panel. The touch panel may include at least one touch sensor detecting a touch. For example, the touch sensor may include a capacitive touch sensor, a resistive touch sensor, a surface acoustic wave touch sensor, an infrared touch sensor, etc., but is not limited thereto.

The display 1410 and the touch panel may be implemented as one panel. For example, the touch panel may be inserted into the display 1410 (e.g., may be an on-cell type or in-cell type). For example, the touch panel may be added on the display 1410 (e.g., an add-on type).

Meanwhile, the input unit 1500 may include a button, a keypad, a dome switch, a jog wheel, a jog switch, etc., but is not limited thereto.

The memory 1700, which is hardware storing various types of data processed within the aerosol generating device 1000, may store pieces of data processed by the control unit 1200 and pieces of data to be processed by the control unit 1200. The memory 1700 may include at least one type of storage medium from among a flash memory type, a hard disk type, a multimedia card micro type, a card type memory (e.g., a SD or XD memory), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1700 may store data regarding an operation time of the aerosol generating device 1000, the maximum number of puffs, the current number of puffs, at least one temperature profile, and a smoking pattern of the user.

The communication unit 1600 may include at least one component for communication with another electronic device. For example, the communication unit 1600 may include at least one of a short-range wireless communication unit and a wireless communication unit.

The short-range wireless communication unit may include a Bluetooth communication unit, a Bluetooth low energy (BLE) communication unit, a near field communication unit, a wireless local area network ((WLAN) (Wi-Fi)) communication unit, a Zigbee communication unit, an infrared data association (IrDA) communication unit, a Wi-Fi Direct (WFD) communication unit, an ultra wideband (UWB) communication unit, an Ant+ communication unit, etc., but is not limited thereto.

The wireless communication unit may include a cellular network communication unit, an Internet communication unit, a computer network (e.g., LAN or WAN) communication unit, etc., but is not limited thereto.

Although not shown in FIG. 19, the aerosol generating device 1000 may further include a connection interface such as a universal serial bus (USB) interface, and may be connected to another external device through the connection interface such as the USB interface to transmit and receive information or charge the power supply 1100.

The control unit 1200 may control an overall operation of the aerosol generating device 1000. In an embodiment, the control unit 1200 may include at least one processor. The processor may be implemented as an array of a plurality of logic gates or may be implemented as a combination of a general-purpose microprocessor and a memory that stores a program executable by the microprocessor. In addition, one of ordinary skill in the art to which the present embodiment pertains may understand that the processor may be implemented as other types of hardware.

The control unit 1200 may control the temperature of the heater 1800 by controlling supply power from the power supply 1100 to the heater 1800. The control unit 1200 may control the temperature of the cartridge heater 2400 and/or the heater 1800 based on the temperature of the cartridge heater 2400 and/or the heater 1800 sensed by the temperature sensor 1310. The control unit 1200 may adjust power supplied to the cartridge heater 2400 and/or the heater 1800, based on the temperature of the cartridge heater 2400 and/or the heater 1800. For example, the control unit 1200 may determine a target temperature with respect to the cartridge heater 2400 and/or the heater 1800, based on a temperature profile stored in the memory 1700.

The aerosol generating device 1000 may include a power supply circuit (not shown) electrically connected to the power supply 1100 between the power supply 1100 and the cartridge heater 2400 and/or the heater 1800. The power supply circuit may be electrically connected to the cartridge heater 2400, or the heater 1800. The power supply circuit may include at least one switching element. The switching element may be implemented by a bipolar junction transistor (BJT), a field effective transistor (FET), etc. The control unit 1200 may control the power supply circuit.

The control unit 1200 may control power supply by controlling switching of the switching element of the power supply circuit. The power supply circuit may be an inverter that converts DC power output from the power supply 1100 into AC power. For example, the inverter may include a full-bridge circuit or a half-bridge circuit including a plurality of switching elements.

The control unit 1200 may turn on the switching element so that power is supplied from the power supply 1100 to the cartridge heater 2400 and/or the heater 1800. The control unit 1200 may turn off the switching element to cut off the supply of power to the cartridge heater 2400 and/or the heater 1800. The control unit 1200 may adjust a current supplied from the power supply 1100 by adjusting a frequency and/or duty ratio of a current pulse input into the switching element.

The control unit 1200 may control a voltage output from the power supply 1100 by controlling switching of the switching element of the power supply circuit. The power conversion circuit may convert the voltage output from the power supply 1100. For example, the power conversion circuit may include a buck-converter that steps down the voltage output from the power supply 1100. For example, the power conversion circuit may be implemented through a buck-boost converter, a zener diode, etc.

The control unit 1200 may adjust a level of the voltage output from the power conversion circuit by controlling an on/off operation of the switching element included in the power conversion circuit. When the switching element continues to be turned on, the level of the voltage output from the power conversion circuit may correspond to a level of a voltage output from the power supply 1100. The duty ratio for the on/off operation of the switching element may correspond to a ratio of the voltage output from the power conversion circuit to the voltage output from the power supply 1100. The level of the voltage output from the power conversion circuit may decrease as the duty ratio with respect to the on/off operation of the switching element decreases. The heater 1800 may be heated based on the voltage output from the power conversion circuit.

The control unit 1200 may control power to be supplied to the heater 1800 by using at least one of a pulse width modulation (PWM) method and a proportional-integral-differential (PID) method.

For example, the control unit 1200 may control a current pulse having a certain frequency and duty ratio to be supplied to the heater 1800 by using the PWM method. The control unit 1200 may control the power supplied to the heater 1800 by adjusting the frequency and duty ratio of the current pulse.

For example, the control unit 1200 may determine a target temperature to be controlled, based on the temperature profile. The control unit 1200 may control the power supplied to the heater 1800 by using the PID method, which is a feedback control method through a difference value between the temperature of the heater 1800 and the target temperature, a value obtained by integrating the difference value over time, and a value obtained by differentiating the difference value over time.

The control unit 1200 may prevent the cartridge heater 2400 and/or the heater 1800 from overheating. For example, on the basis that the temperature of the cartridge heater 2400 and/or the heater 1800 exceeds a preset limit temperature, the control unit 1200 may control an operation of the power conversion circuit so that the supply of power to the cartridge heater 2400 and/or the heater 1800 stops. For example, on the basis that the temperature of the cartridge heater 2400 and/or the heater 1800 exceeds the preset limit temperature, the control unit 1200 may reduce an amount of power supplied to the cartridge heater 2400 and/or the heater 1800 by a certain ratio. For example, on the basis that the temperature of the cartridge heater 2400 exceeds the preset limit temperature, the control unit 1200 may determine that the aerosol generating material accommodated in the cartridge 19 is exhausted and cut off the power supply to the cartridge heater 2400.

The control unit 1200 may control charging and discharging of the power supply 1100. The control unit 1200 may identify the temperature of the power supply 1100 based on an output signal of the temperature sensor 1310.

When a power line is connected to a battery terminal of the aerosol generating device 1000, the control unit 1200 may identify whether the temperature of the power supply 1100 is a first limit temperature or more which is a reference for blocking charging of the power supply 1100. When the temperature of the power supply 1100 is less than the first limit temperature, the control unit 1200 may control the power supply 1100 to be charged, based on a preset charging current. The control unit 1200 may block charging of the power supply 1100 when the temperature of the power supply 1100 is the first limit temperature or more.

While the power of the aerosol generating device 1000 is turned on, the control unit 1200 may identify whether the temperature of the power supply 1100 is a second limit temperature or more which is a reference for blocking discharge of the power supply 1100. The control unit 1200 may control power stored in the power supply 1100 to be used when the temperature of the power supply 1100 is less than the second limit temperature. When the temperature of the power supply 1100 is the second limit temperature or more, the control unit 1200 may stop using the power stored in the power supply 1100.

The control unit 1200 may calculate the remaining capacity of the power stored in the power supply 1100. For example, the control unit 1200 may calculate the remaining capacity of the power supply 1100 based on a voltage and/or current sensing value of the power supply 1100.

The control unit 1200 may determine, through the insertion detection sensor 1330, whether the aerosol generating article is inserted into the insertion space. The control unit 1200 may determine that the aerosol generating article is inserted, based on the output signal of the insertion detection sensor 1330. When determining that the aerosol generating article is inserted into the insertion space, the control unit 1200 may control power to be supplied to the cartridge heater 2400 and/or the heater 1800. For example, the control unit 1200 may supply power to the cartridge heater 2400 and/or the heater 1800, based on the temperature profile stored in the memory 1700.

The control unit 1200 may determine whether the aerosol generating article is removed from the insertion space. For example, the control unit 1200 may determine, through the insertion detection sensor 1330, whether the aerosol generating article is removed from the insertion space. For example, when the temperature of the heater 1800 is the preset limit temperature or more or when a temperature change gradient of the heater 1800 is a set gradient, the control unit 1200 may determine that the aerosol generating article is removed from the insertion space. When it is determined that the aerosol generating article is removed from the insertion space, the control unit 1200 may cut off the supply of power to the cartridge heater 2400 and/or the heater 1800.

The control unit 1200 may control a power supply time and/or a power supply amount with respect to the heater 1800, according to a state of the aerosol generating article detected by the sensor 1300. The control unit 1200 may identify, based on a look-up table, a level range including a level of a signal of the capacitance sensor. The control unit 1200 may determine an amount of moisture in the aerosol generating article, according to the identified level range.

When the aerosol generating article is over-humidified, the control unit 1200 may increase a preheating time of the aerosol generating article compared to a normal state by controlling the power supply time with respect to the heater 1800.

The control unit 1200 may determine, through the reuse detection sensor 1340, whether the aerosol generating article inserted into the insertion space is reused. For example, the control unit 1200 may compare a sensing value of a signal of the reuse detection sensor 1340 with a first reference range including a first color and when the sensing value is included in the first reference range, determine that the aerosol generating article is not used. For example, the control unit 1200 may compare the sensing value of the signal of the reuse detection sensor 1340 with a second reference range including a second color and when the sensing value is included in the second reference range, determine that the aerosol generating article is used. When it is determined that the aerosol generating article is used, the control unit 1200 may cut off the supply of power to the cartridge heater 2400 and/or the heater 1800.

The control unit 1200 may determine, through the cartridge detection sensor 1350, whether the cartridge 19 is coupled and/or removed. For example, the control unit 1200 may determine whether the cartridge 19 is coupled or removed, based on a sensing value of the signal of the cartridge detection sensor 1350.

The control unit 1200 may determine whether the aerosol generating material of the cartridge 19 is exhausted. For example, the control unit 1200 may apply power to preheat the cartridge heater 2400 and/or the heater 1800, determine whether the temperature of the cartridge heater 2400 exceeds the limit temperature in a preheating period, and when the temperature of the cartridge heater 2400 exceeds the limit temperature, determine that the aerosol generating material of the cartridge 19 is exhausted. When it is determined that the aerosol generating material of the cartridge 19 is exhausted, the control unit 1200 may cut off the supply of power to the cartridge heater 2400 and/or the heater 1800.

The control unit 1200 may determine whether the cartridge 19 may be used. When the current number of puffs is greater than or equal to the maximum number of puffs set in the cartridge 19, the control unit 1200 may determine, based on the data stored in the memory 1700, that the cartridge 19 may not be used. For example, when the total time for which the heater cartridge 2400 is heated is a preset maximum time or more or the total amount of power supplied to the cartridge heater 2400 is a preset maximum amount of power or more, the control unit 1200 may determine that the cartridge 19 may not be used.

The control unit 1200 may determine inhalation by the user through the puff sensor 1320. For example, the control unit 1200 may determine whether a puff occurs, based on a sensing value of a signal of the puff sensor 1320. For example, the control unit 1200 may determine an intensity of the puff, based on the sensing value of the signal of the puff sensor 1320. When the number of puffs reaches the preset maximum number of puffs or when puffs are not detected for a preset time or more, the control unit 1200 may cut off the supply of power to the cartridge heater 2400 and/or the heater 1800.

The control unit 1200 may determine, through the cap detection sensor 1360, whether a cap is coupled and/or removed. For example, the control unit 1200 may determine whether the cap is coupled and/or removed, based on a sensing value of a signal of the cap detection sensor 1360.

The control unit 1200 may control the output unit 1400 based on the result of detection by the sensor 1300. For example, when the number of puffs counted through the puff sensor 1320 reaches a preset number, the control unit 1200 may notify the user that the aerosol generating device 1000 is soon terminated, through at least one of the display 1410, the haptic unit 1420, or the sound output unit 1430. For example, the control unit 1200 may notify the user through the output unit 1400, based on the determination that the aerosol generating article is not present in the insertion space. For example, the control unit 1200 may notify the user through the output unit 14, based on the determination that the cartridge 19 and/or the cap are not mounted. For example, the control unit 1200 may transmit information about the temperature of the cartridge heater 2400 and/or the heater 1800 to the user through the output unit 1400.

The control unit 1200 may store and update, in the memory 1700, a history of a certain event that occurs, based on the occurrence of the event. The event may include detection of insertion of the aerosol generating article, initiation of heating of the aerosol generating article, detection of puffs, termination of the puffs, detection of overheating of the cartridge heater 2400 and/or the heater 1800, detection of application of an overvoltage to the cartridge heater 2400 and/or the heater 1800, termination of heating of the aerosol generating article, an operation such as power on/off of the aerosol generating device 1000, initiation of charging of the power supply 1100, detection of overcharging of the power supply 1100, termination of charging of the power supply 1100, etc. The history of the event may include a date and time when the event occurs, log data corresponding to the event, etc. For example, when the certain event is the detection of insertion of the aerosol generating article, the log data corresponding to the event may include data regarding the sensing value of the insertion detection sensor 1330. For example, when the certain event is the detection of overheating of the cartridge heater 2400 and/or the heater 1800, the log data corresponding to the event may include data regarding the temperature of the cartridge heater 2400 and/or the heater 1800, the voltage applied to the cartridge heater 2400 and/or the heater 1800, a current flowing through the cartridge heater 2400 and/or the heater 1800, etc.

The control unit 1200 may control to form a communication link with an external device such as a mobile terminal of the user. When data regarding authentication is received from the external device through the communication link, the control unit 1200 may release a restriction on use of at least one function of the aerosol generating device 1000. Here, the data regarding the authentication may include data indicating completion of user authentication with respect to the user corresponding to the external device. The user may perform the user authentication through the external device. The external device may determine whether user data is valid, based on the birthday of the user, a unique number indicating the user, etc. and receive, from an external server, data regarding use authority over the aerosol generating device 1000. The external device may transmit the data indicating the completion of the user authentication to the aerosol generating device 1000, based on the data regarding the use authority. When the user authentication is completed, the control unit 1200 may release the restriction on the use of at least one function of the aerosol generating device 1000. For example, when the user authentication is completed, the control unit 1200 may release a restriction on use of a heating function of supplying power to the heater 1800.

The control unit 1200 may transmit data regarding the state of the aerosol generating device 1000 to the external device through the communication link formed with the external device. Based on the received data regarding the state, the external device may output the remaining capacity of the power supply 1100 of the aerosol generating device 1000, an operation mode, etc. through a display of the external device.

The external device may transmit a location search request to the aerosol generating device 1000, based on an input for initiating a location search of the aerosol generating device 1000. When receiving the location search request from the external device, the control unit 1200 may control at least one of output devices to perform an operation corresponding to the location search, based on the received location search request. For example, the haptic unit 1420 may generate vibration in response to the location search request. For example, the display 1410 may output an object corresponding to the location search and an end of the search in response to the location search request.

When receiving firmware data from the external device, the control unit 1200 may control to perform a firmware update. The external device may identify a current version of firmware of the aerosol generating device 1000 and determine whether a new version of the firmware is present. When an input for requesting firmware download is received, the external device may receive a new version of firmware data and transmit the new version of firmware data to the aerosol generating device 1000. When receiving the new version of firmware data, the control unit 1200 may control the firmware update of the aerosol generating device 1000 to be performed.

The control unit 1200 may transmit data regarding a sensing value of at least one sensor 1300 to the external server (not shown) through the communication unit 16, and receive from the server and store a learning model generated by learning the sensing value through machine learning such as deep learning. The control unit 1200 may perform an operation of determining an inhalation pattern of the user, an operation of generating a temperature profile, etc. by using the learning model received from the server. The control unit 1200 may store, in the memory 1700, sensing value data of at least one sensor 1300, data for training an artificial neural network (ANN), etc. For example, the memory 1700 may store a database with respect to each component provided in the aerosol generating device 1000, which is for training the ANN, and weights and biases constituting the structure of the ANN. The control unit 1200 may generate at least one learning model used for determining the inhalation pattern of the user, generating the temperature profile, etc., by learning data regarding the sensing value of the at least one sensor 1300, the inhalation pattern of the user, the temperature profile, etc. which are stored in the memory 1700.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

The embodiments described above, or other embodiments, are not mutually exclusive or distinct from each other. The embodiments described above, or other embodiments, may be used in combination or have their respective configurations or functions integrated.

For example, this means that the A configuration described in a particular embodiment and/or drawing may be combined with the B configuration described in another embodiment and/or drawing. That is, even though a combination of configurations is not explicitly described, it means that the combination is possible unless it is explicitly stated that such a combination is impossible.

The above detailed description should not be construed as limiting in any way but should be considered as illustrative. The scope of the disclosure should be determined by the reasonable interpretation of the appended claims, and all modifications within the equivalent scope of the disclosure are included in the scope of the disclosure.

According to various embodiments, by detecting a type of an inserted aerosol generating article, an aerosol generating device may perform heating according to a temperature profile corresponding to the detected type of aerosol generating article, and provide an optimal smoking feeling to a user.

What is claimed is:

1. An aerosol generating system comprising:
an aerosol generating article comprising a first region in which an identification material emitting light of a second wavelength different from a first wavelength, when excited by light of the first wavelength, is disposed, and a second region different from the first region; and
an aerosol generating device having a cavity in which a part of the aerosol generating article is accommodated,
wherein the aerosol generating device comprises:
an inner wall defining the cavity and comprising, at one region, a transparent region through which light is transmitted;
a sensor module comprising a light emitting unit configured to emit the light of the first wavelength toward the first region through the transparent region, and a light receiving unit configured to receive the light of the second wavelength emitted from the identification material of the aerosol generating article through the transparent region;
a heater configured to heat the aerosol generating article accommodated in the cavity; and
a control unit configured to determine information of the aerosol generating article based on a sensing value sensed through the light receiving unit, and control power supply to the heater based on the determined information of the aerosol generating article.

2. The aerosol generating system of claim 1, wherein
in the sensor module, the light emitting unit is configured to emit the light of the first wavelength toward the first region and the second region through the transparent region,
the light receiving unit includes a plurality of light receiving units,
the plurality of light receiving units include a first light receiving unit configured to receive the light of the second wavelength emitted from the identification material of the aerosol generating article through the transparent region, and a second light receiving unit configured to receive light reflected from the second region through the transparent region, and
the control unit is configured to determine the information of the aerosol generating article based on a first sensing value sensed through the first light receiving unit, and a second sensing value sensed through the second light receiving unit.

3. The aerosol generating system of claim 1, wherein,
in the sensor module, the light emitting unit and the light receiving unit respectively include a plurality of light emitting units and a plurality of light receiving units,
the plurality of light emitting units include a first light emitting unit configured to emit the light of the first wavelength toward the first region through the transparent region, and a second light emitting unit configured to emit the light of the first wavelength toward the second region through the transparent region,
the plurality of light receiving units include a first light receiving unit configured to receive the light of the second wavelength emitted from the identification material of the aerosol generating article through the transparent region, and a second light receiving unit configured to receive light reflected from the second region through the transparent region, and
the control unit is configured to determine the information of the aerosol generating article based on a first sensing value sensed through the first light receiving unit, and a second sensing value sensed through the second light receiving unit.

4. The aerosol generating system of claim 1, wherein the sensor module is movably disposed in the aerosol generating device to move to a first position corresponding to the first region and a second position corresponding to the second region.

5. The aerosol generating system of claim 4, wherein
the control unit is configured to determine the information of the aerosol generating article based on a first sensing value sensed at the first position through the sensor module, and a second sensing value sensed at the second position through the sensor module.

6. The aerosol generating system of claim 3, wherein
the aerosol generating article further includes a third region symmetrical to the second region with respect to the first region,
the heater is disposed closer to the third region than to the second region of the aerosol generating article accommodated in the cavity,
the plurality of light emitting units further include a third light emitting unit configured to emit the light of the first wavelength toward the third region through the transparent region,
the plurality of light receiving units further include a third light receiving unit configured to receive light reflected from the third region through the transparent region, and
the control unit is configured to determine the information of the aerosol generating article based on the first sensing value, the second sensing value, and a third sensing value sensed through the third light receiving unit.

7. The aerosol generating system of claim 4, wherein
the aerosol generating article further includes a third region symmetrical to the second region with respect to the first region,
the heater is disposed closer to the third region than to the second region of the aerosol generating article accommodated in the cavity, and
the sensor module is movably disposed in the aerosol generating device to move to the first position, the second position, and a third position corresponding to the third region.

8. The aerosol generating system of claim 7, wherein
the control unit is configured to determine the information of the aerosol generating article based on a first sensing value sensed at the first position through the sensor module, a second sensing value sensed at the second position through the sensor module, and a third sensing value sensed at the third position through the sensor module.

9. The aerosol generating system of claim 2, wherein the control unit is configured to determine the information of the aerosol generating article based on a value obtained by subtracting the second sensing value from the first sensing value.

10. The aerosol generating system of claim 6, wherein the control unit is configured to determine the information of the aerosol generating article based on a value obtained by subtracting an average value of the second sensing value and the third sensing value from the first sensing value.

11. The aerosol generating system of claim 1, wherein the control unit is configured to control power supplied to the heater based on a temperature profile corresponding to a determined type of the aerosol generating article.

12. The aerosol generating system of claim 1, wherein the light receiving unit includes a red, green, blue (RGB) optical diode.

13. The aerosol generating system of claim 1, wherein the identification material includes at least one of a lanthanide material or a taggant material.

14. The aerosol generating system of claim 1, wherein
the aerosol generating device further includes an output unit configured to output information about a state of the aerosol generating device, and
the control unit is configured to control the output unit to output the determined information of the aerosol generating article.

15. The aerosol generating system of claim 14, wherein the output unit includes at least one of a display, a haptic unit, or a sound output unit.
